(19) United States
(12) Patent Application Publication
(10) Pub. No.: US 2026/0043269 A1
(43) Pub. Date: Feb. 12, 2026

(54) LATCHING ASSEMBLY WITH SLIDE HANDLE

(71) Applicant: ASSA ABLOY Americas Residential Inc., New Haven, CT (US)

(72) Inventors: Bingo Wang, Xiamen (CN); XinPeng Lin, Xiamen (CN); Oscar Romero, Laguna Woods, CA (US); Wei Hsu, Lake Forest, CA (US); Yos Singtoroj, Foothill Ranch, CA (US); Hanna Farag, Jurupa Valley, CA (US); Jack Zhang, Xiamen (CN)

(21) Appl. No.: 19/267,796

(22) Filed: Jul. 14, 2025

Related U.S. Application Data
(60) Provisional application No. 63/681,546, filed on Aug. 9, 2024.

(51) Int. Cl. E05B 1/00; E05B 1/04

(52) U.S. Cl. CPC E05B 1/0046; E05B 1/0092; E05B 1/04

(57) ABSTRACT

A handle assembly for a door includes a handle, an escutcheon plate, a drive assembly, and a transmission assembly. The escutcheon plate is configured to mount to a face of the door. The transmission assembly includes a spring, compression bracket, and a latch pinion. At least a portion of the drive assembly extends from the handle through the escutcheon plate and into the transmission assembly contacting the compression bracket. The handle is slidable in a slide direction parallel to the face of the door between a latched position and an unlatched position. The handle is biased towards the latched position and the transmission assembly is coupled to a latch assembly for extension and retraction of a latch bolt.

### CROSS-REFERENCE TO RELATED APPLICATION(S)

This application claims priority to and the benefit of U.S. Provisional Application No. 63/681,546, filed Aug. 9, 2024, the disclosure of which is hereby incorporated by reference in its entirety.

### TECHNICAL FIELD

This invention relates to the field of door handlesets and door locks. More particularly, this invention relates to a sliding handle door handleset having a handle assembly that operationally drives a latching assembly.

### BACKGROUND

Door handlesets and latches are commonly installed in residential and commercial settings. The handlesets include a latch assembly that is actuatable by a mechanism. Latch assemblies are used for maintaining a door in a closed position using a bolt that moves between extended and retracted positions. In existing latch assemblies, the bolt is actively pulled between the extended and retracted positions. This pulling of the bolt is often the result of turning a door knob or a thumbpiece of the handleset. In the existing latch assemblies, the latch assemblies are spring latches, which means that the latch is spring loaded all the time, and the latch is only retracted when the user operates the knob or the thumbpiece mounted on the face of the handleset.

The pushing and pulling of the bolt may also be accomplished by the actuation of the handleset. Some handlesets include a stationary handle and a pivotable thumb actuator. To actuate the latch, a user is required to depress the thumb actuator which may require significant push force. The thumb actuators require additional hand mobility and dexterity to operate. The thumb actuators are also a separate piece located above the handle of the handlesets, which is visually unappealing.

### SUMMARY

In general terms, this disclosure is directed to a latching assembly with slide handle. In certain embodiments, and by non-limiting example, a handle assembly for a door includes a handle, an upper escutcheon plate, a transmission assembly, and a handle slide pin. The upper escutcheon plate is mounted to a face of the door. The transmission assembly includes a spring, compression bracket, and a latch pinion. The handle slide pin extends from the handle through the upper escutcheon plate and into the transmission assembly and contacts the compression bracket. The handle is slidable in a slide direction parallel to the face of the door between a latched position and an unlatched position. The handle and the handle slide pin are spring biased to the latched position by the spring. The spring is engaged with the compression bracket. The spring is compressible in response to the handle moving from the latched position to the unlatched position. The compression bracket moves with the handle slide pin and rotating a latch pinion.

In certain embodiments, and by non-limiting example, a method of unlatching a door with a handle assembly is provided. The method includes moving a handle in a linear slide direction parallel to an outer surface of the door from a latched position to an unlatched position. Moving a handle slide pin in the slide direction in response to the linear movement of the handle. Moving a compression bracket in the slide direction in response to the linear movement of the handle slide pin. Rotating a latch pinion about a rotation axis in response to engagement of the latch pinion by the linear movement of the compression bracket. And rotating a latch driver from the latched position to the unlatched position about the rotation axis in conjunction with rotation of the latch pinion.

In certain embodiments, and by non-limiting example, a handle assembly for a door includes a handle, a transmission assembly, and a handle slide pin. The handle is movable in a slide direction between a first position and a second position parallel to a face of the door. The handle slide pin extends from the handle to the transmission assembly. The handle slide pin is movable in response to movement of the handle. The transmission assembly has a compression bracket with a rack and a latch pinion engaged with the rack such that linear movement of the rack causes rotational movement of the latch pinion. The compression bracket is movable in response to movement of the handle slide pin. The first position defines a latched state, and the second position defines an unlatched state.

In certain embodiments, and by non-limiting example, a handle assembly for a door includes at least one escutcheon plate having a front face and an opposite rear face. The rear face configured to mount on a face of a door and the at least one escutcheon plate also having a first plate end and an opposite second plate end defining a longitudinal axis. A handle has a first handle end and an opposite second handle end, the handle elongated along the longitudinal axis. The first and second handle ends each slidably coupled to the front face of the at least one escutcheon plate such that the handle is moveable between at least a latched position and an unlatched position along the longitudinal axis and relative to the at least one escutcheon plate. A transmission assembly is mounted on the rear face of the at least one escutcheon plate. The transmission assembly includes a bracket, a spring biasing a longitudinal position of the bracket, and a pinion rotatable around a rotation axis that is orthogonal to the longitudinal axis. A drive assembly operationally couples the handle to the transmission assembly. The drive assembly includes a drive arm extending through the at least one escutcheon plate and having a first end engaged with the bracket of the transmission assembly and a second end disposed within the handle. Movement of the handle between the latched position and the unlatched position drives longitudinal movement of the bracket of the transmission assembly via the drive arm for rotation of the pinion around the rotation axis.

In certain embodiments, and by non-limiting example, a handle assembly for a door includes at least one escutcheon plate configured to mount on a face of a door and defining a longitudinal axis. A handle includes a first handle mount, a second handle mount, and a grip portion extending between the first and second handle mounts. The grip portion is elongated along the longitudinal axis and the first and second handle mounts extending in a transverse direction orthogonal to the longitudinal axis. The first and second handle mounts each are slidably coupled to the at least one escutcheon plate such that the handle is moveable between at least a latched position and an unlatched position along the longitudinal axis and relative to the at least one escutcheon plate. A transmission assembly is mounted to the at least one escutcheon plate opposite the handle. The transmission assembly includes a bracket, a first spring biasing a longitudinal position of the bracket, and a rotatable pinion such that longitudinal movement is converted to rotational movement. A drive assembly operationally couples the handle to the transmission assembly. The drive assembly includes a drive arm extending through the at least one escutcheon plate and having a first end engaged with the bracket of the transmission assembly and a second end disposed within the first handle mount of the handle. The drive arm is pivotable about a pivot point disposed between the first end and the second end. A second spring is disposed within the second handle mount of the handle and configured to bias the handle towards the latched position.

In certain embodiments, and by non-limiting example, a method of unlatching a door with a handle assembly includes providing the handle assembly in a latched configuration on the door. The handle assembly including at least one escutcheon plate defining a longitudinal axis mounted vertically on the door and a handle slidably coupled to the at least one escutcheon plate. The handle is biased towards a latched position. The handle is moved in a linear sliding direction along the longitudinal axis from the latched position towards an unlatched position. In response to the linear movement of the handle, the drive arm moves via the handle. The drive arm is coupled to a transmission assembly having a bracket, a spring biasing a longitudinal position of the bracket, and a rotatable pinion. The bracket moves via the drive arm along the longitudinal axis. The pinion rotates around a rotation axis orthogonal to the longitudinal axis via the bracket and to rotate a latch driver of the handle assembly. Thereby, defining an unlatched configuration of the handle assembly and rotation of the pinion causes a latch bolt of an attached latch assembly to retract relative to the door.

### BRIEF DESCRIPTION OF THE DRAWINGS

FIG. 1 is a front perspective view of an example handle assembly.

FIG. 2 is a rear perspective view of the handle assembly of FIG. 1.

FIG. 3 is a front view of the handle assembly of FIG. 1.

FIG. 4 is a rear view of the handle assembly of FIG. 1.

FIG. 5 is an exploded front perspective view of the handle assembly of FIG. 1.

FIG. 6 is a front perspective view of an example lower escutcheon plate.

FIG. 7 is a rear perspective view of the lower escutcheon plate of FIG. 6.

FIG. 8 is a front perspective view of an example upper escutcheon plate.

FIG. 9 is a rear perspective view of the upper escutcheon plate in FIG. 8.

FIG. 10 is a front perspective view of an example handle.

FIG. 11 is a rear perspective view of the handle of FIG. 10.

FIG. 12 is a front perspective view of an example lower handle mount.

FIG. 13 is a rear perspective view of the lower handle mount of FIG. 12.

FIG. 14 is a front perspective view of an example transmission assembly.

FIG. 15 is a rear perspective view of the transmission assembly of FIG. 14.

FIG. 16 is a front view of the transmission assembly of FIG. 14.

FIG. 17 is a rear view of the transmission assembly of FIG. 14.

FIG. 18 is an exploded view of the transmission assembly of FIG. 14.

FIG. 19 is a front perspective view of an example front faceplate.

FIG. 20 is a rear perspective view of the front faceplate of FIG. 19.

FIG. 21 is a front perspective view of an example compression bracket.

FIG. 22 is a rear perspective view of the compression bracket of FIG. 21.

FIG. 23 is a front perspective view of an example rear faceplate.

FIG. 24 is a rear perspective view of the rear faceplate of FIG. 23.

FIG. 25 is a perspective view of an example handle slide pin.

FIG. 26 is front perspective view of an example latch pinion.

FIG. 27 is a rear perspective view of the latch pinion of FIG. 26.

FIG. 28 is a front perspective view of an example driver rotator.

FIG. 29 is a rear perspective view of the driver rotator of FIG. 28.

FIG. 30 is a front perspective view of an example latch driver.

FIG. 31 is a rear perspective view of the latch driver of FIG. 30.

FIG. 32 is a perspective view of an example pinion pin.

FIG. 33 is a cross-sectional side view of the handle assembly of FIG. 1 in a first configuration.

FIG. 34 is a focused cross-sectional view of the handle assembly of FIG. 33.

FIG. 35 is a focused rear view of the handle assembly of FIG. 33.

FIG. 36 is a cross-sectional side view of the handle assembly of FIG. 1 in a second configuration.

FIG. 37 is a focused cross-sectional view of the handle assembly of FIG. 36.

FIG. 38 is a focused rear view of the handle assembly of FIG. 36.

FIG. 39 is a front perspective view of another example of a handle assembly.

FIG. 40 is a front perspective view of another example of a handle assembly.

FIG. 41 is a front perspective view of another example of a handle assembly.

FIG. 42 is an exploded front perspective view of the handle assembly of FIG. 41.

FIG. 43 is a cross-sectional view of the handle assembly of FIG. 41 in a latched configuration.

FIG. 44 is a cross-sectional view of the handle assembly of FIG. 41 in an unlatched configuration.

FIGS. 45-46 are perspective views of a portion of a drive assembly for the handle assembly of FIG. 41.

FIGS. 47-48 are perspective view of another portion of the drive assembly for the handle assembly of FIG. 41.

FIG. 49 is a perspective view of a drive arm of the drive assembly shown in FIGS. 45-46.

FIG. 50 is a flowchart illustrating a method for unlatching a door.

FIG. 51 is a cross-sectional view of another example of a handle assembly.

FIG. 52 is a cross-sectional view of another example of a handle assembly.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

This disclosure relates generally to a handle assembly that uses a sliding handle to actuate a latch assembly having a latch bolt that extends and retracts for opening doors without the use of triggers such a thumb trigger typically disposed above a handle or a trigger handle integrated within the handle as described in U.S. Patent Publication No. 2022/0056735 and incorporated by reference herein in its entirety or a rotational thumbpiece. The handle assembly includes a handle that slides against an escutcheon that mounts to a face of a door and in response to a user movement. The handle only moves linearly during operation between a latched position and an unlatched position. The linear movement of the handle is transferred into rotational movement within the handle assembly as so as to drive operation of the latch assembly and the extension and retraction of the corresponding latch bolt.

In certain examples, without the need for triggers or thumbpieces, the handle assembly maximizes aesthetic appeal while also offering improved functionality. Children are able to pull the handle downward from below. Users without free hands could use their elbow to push the handle downward from above. The handle assembly spring biases the handle to the latched position so that the handle assembly automatically returns to a latched configuration upon release.

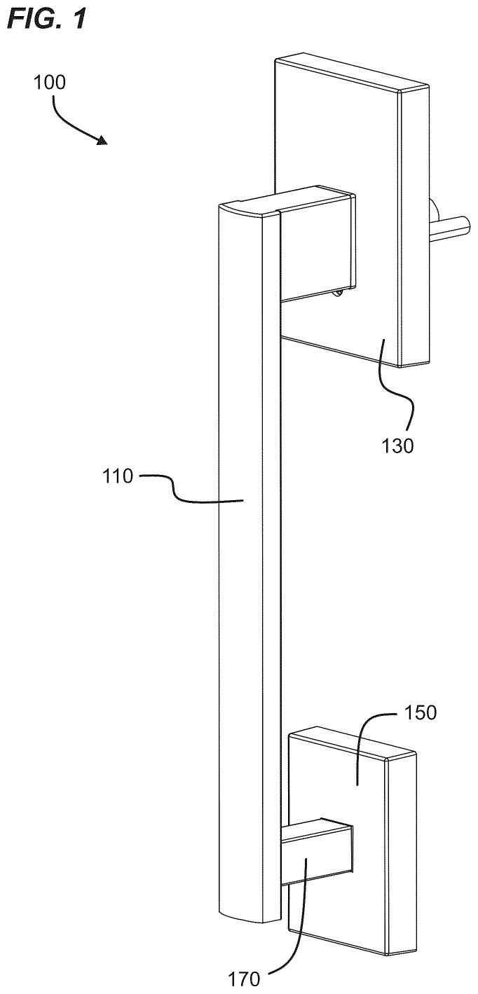

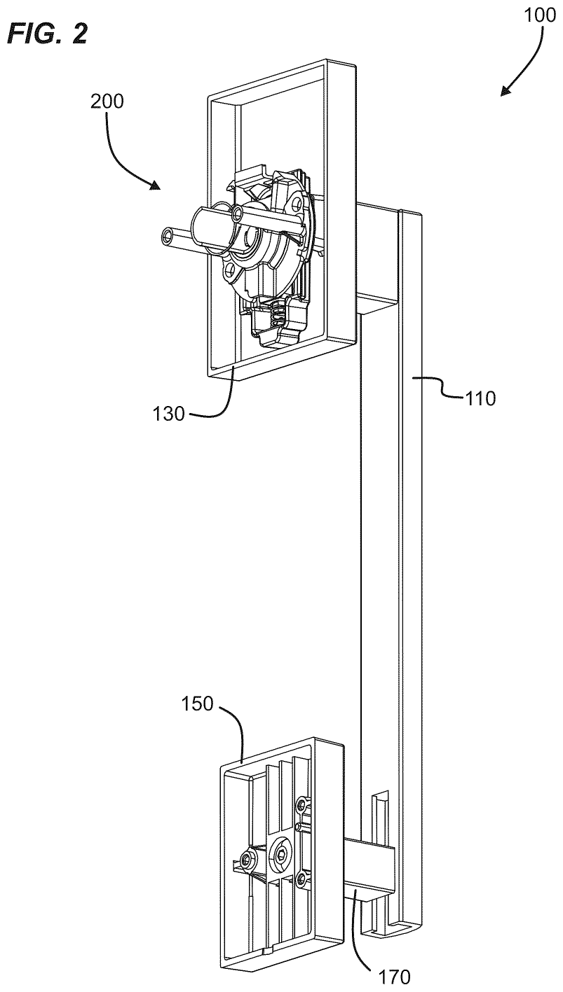

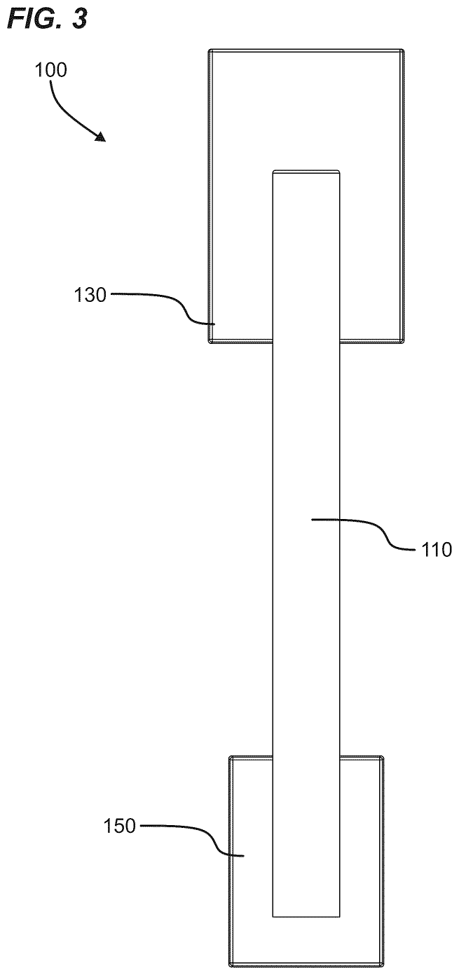

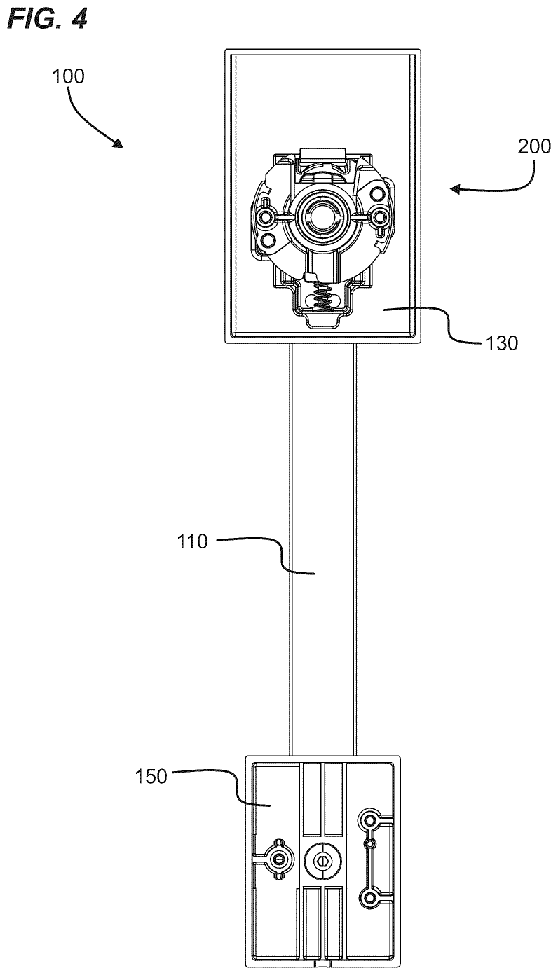

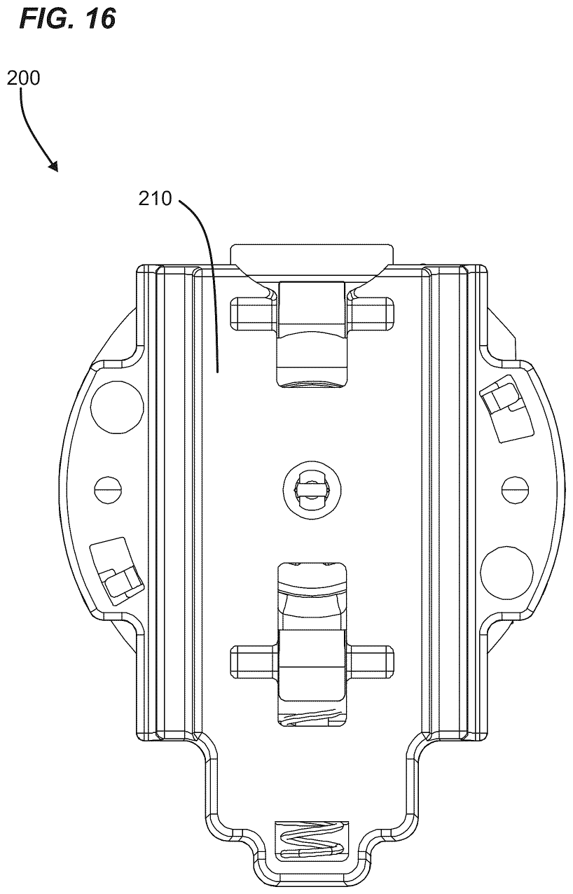

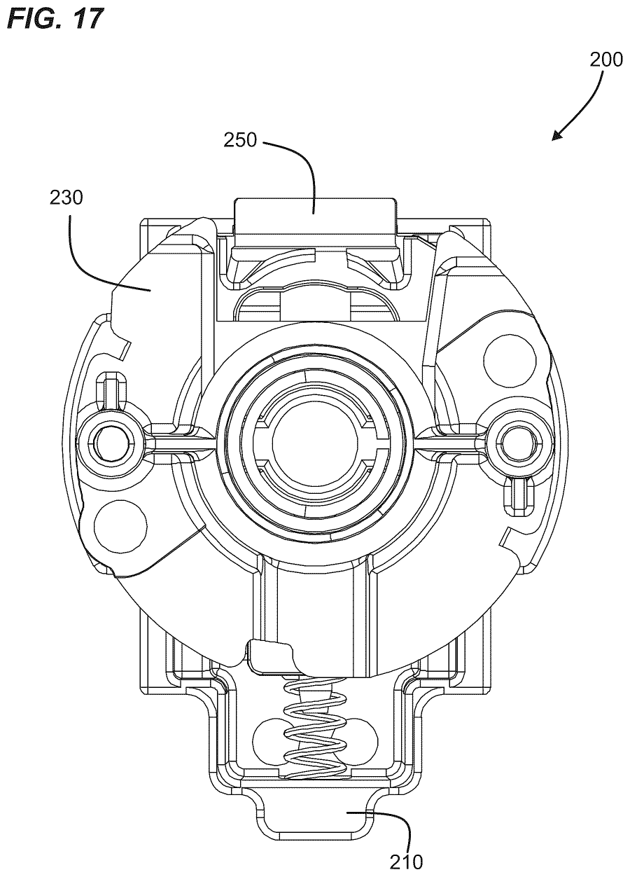

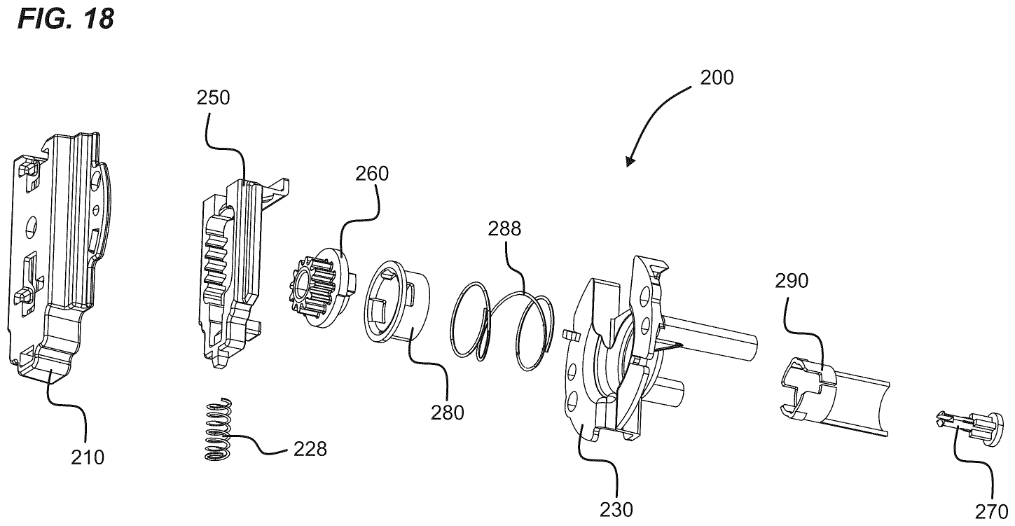

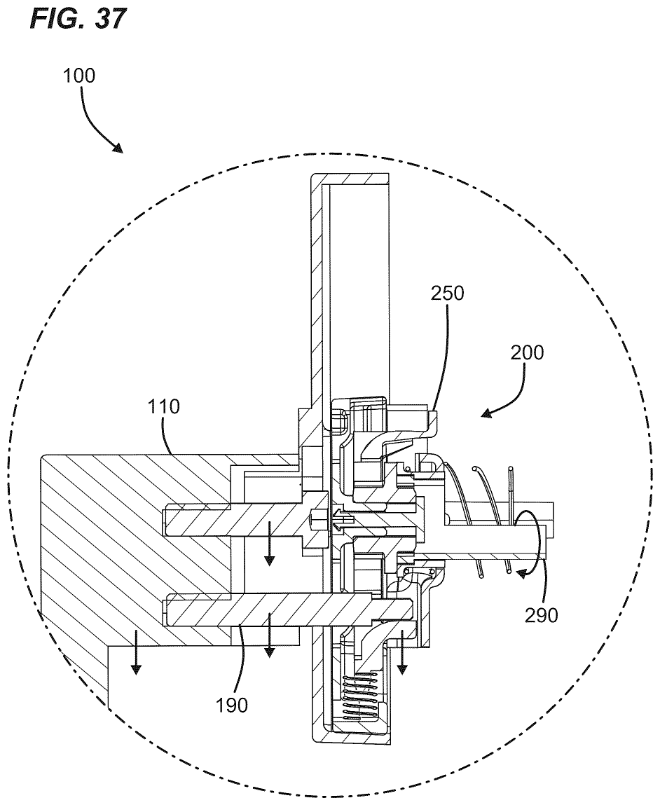

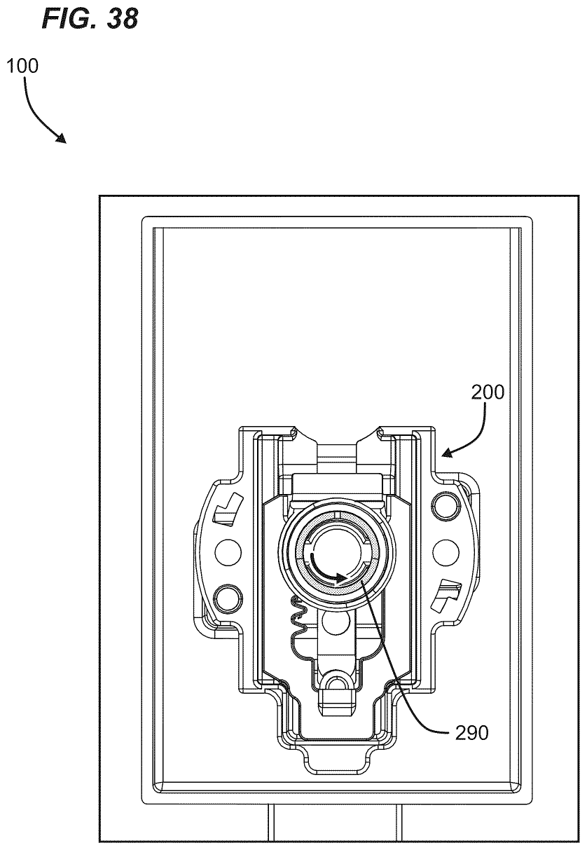

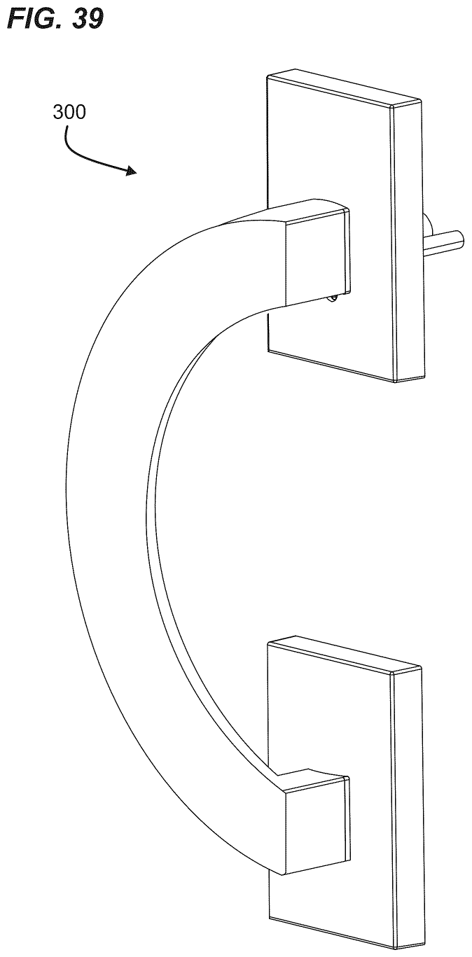

The example handle assembly 100 and associated components shown in FIGS. 1-38 relate to a sliding handle mechanism which drives a latch assembly (not shown) having a latch bolt that extends and retracts from an edge of a door. In certain examples shown in FIGS. 1-4, the handle assembly 100 includes a handle 110, an upper escutcheon plate 130, a lower escutcheon plate 150, a lower handle mount 170, a handle slide pin 190, and a transmission assembly 200.

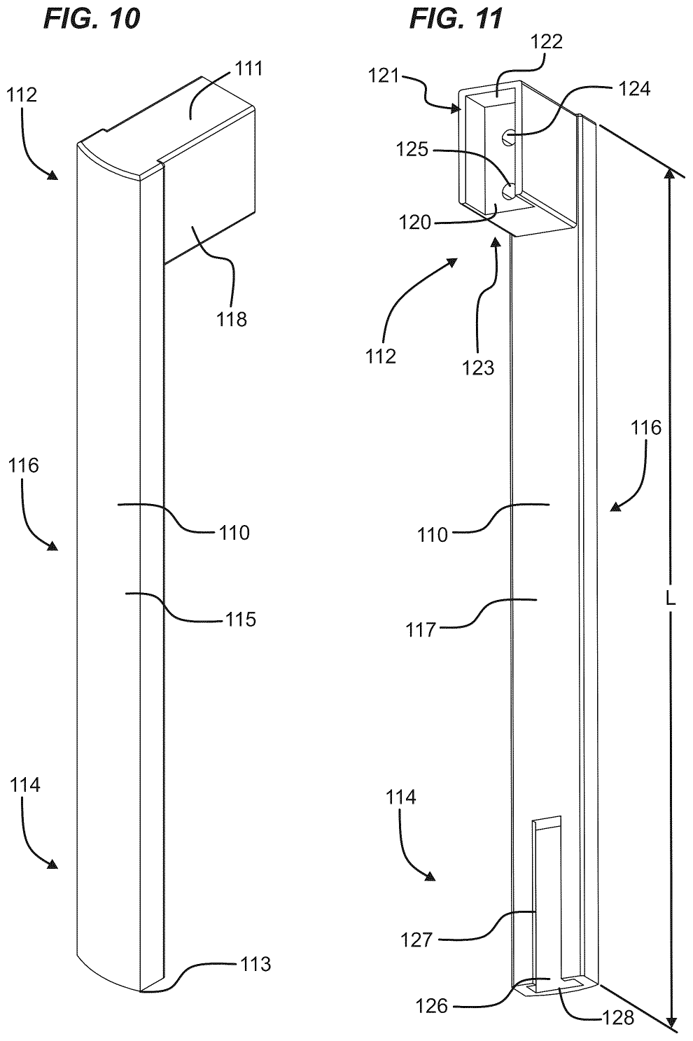

FIGS. 10 and 11 show an example handle 110. In certain examples, the handle 110 extends between a first end 111 and a second end 113 to define a handle length L. The handle 110 includes a first side 115 and an oppositely facing second side 117. In certain examples, the first side 115 is at least partially curved and the second side 117 is flat. In certain examples, the handle 110 includes an upper portion 112, a lower portion 114, and a grip portion 116. The upper portion 112 defines an upper handle mount 118 that extends normal to the length L. The upper handle mount 118 extends from the grip portion 116 to the upper escutcheon plate 130 (shown in FIG. 1) in the assembled state.

In certain examples, the upper handle mount 118 is integral to the handle 110 and in other examples, the upper handle mount 118 is separable from the rest of the handle 110. The upper handle mount 118 includes a slide channel 120. The slide channel 120 has a first open face 121 defined by an end of a channel wall 122. The first open face 121 contacts the upper escutcheon plate 130. In certain examples, the first open face 121 enables downward movement of the handle 110 relative to corresponding stationary features on the upper escutcheon plate 130. The slide channel 120 has a second open face 123 normal to the first open face 121 and defined by a neighboring end of the channel wall 122 such that the first open face 121 and the second open face 123 are joined together to form open sides of the slide channel 120. In certain examples, the second open face 123 extends an intermediate distance from the first open face 121 toward the grip portion 116 of the handle 110. In certain examples, the second open face 123 enables downward movement of the handle 110 relative to corresponding stationary features on the upper escutcheon plate 130, as will be discussed later.

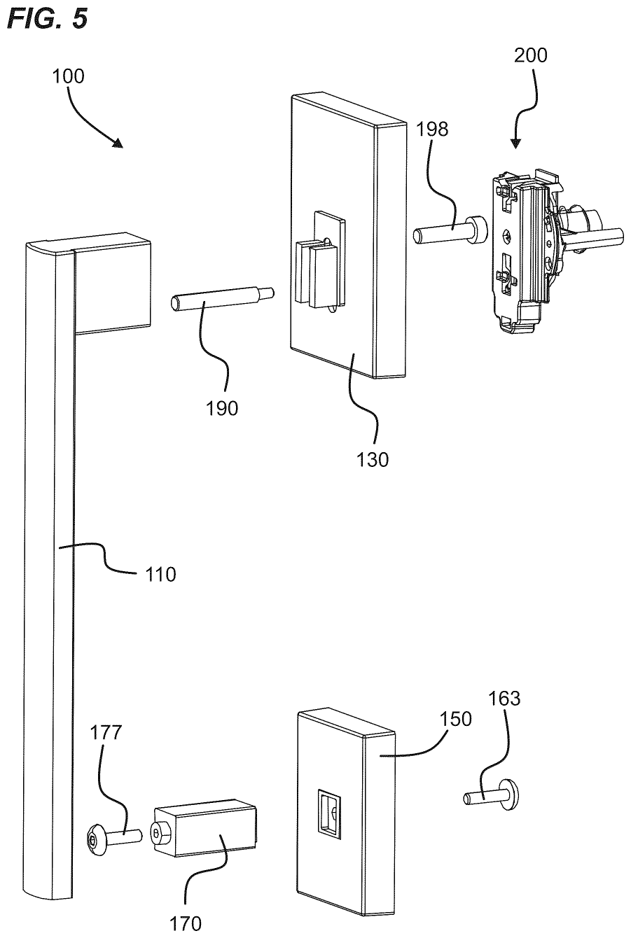

In certain examples, the upper handle mount 118 includes first and second pin cavities 124, 125 that extend normal to the length L of the handle 110 and parallel to each other. The first and second pin cavities 124, 125 include open ends at the slide channel 120. The first pin cavity 124 engages a pin or a bolt, such as bolt 198 shown in FIG. 5. The bolt 198 includes a head that slidably connects to the upper escutcheon plate 130. In certain examples, the first pin cavity 124 is threaded. The second pin cavity 125 engages the handle slide pin 190 (shown in FIG. 5) that extends between the handle 110 and the transmission assembly 200 (shown in FIG. 5). In certain examples, the second pin cavity 125 is threaded.

In certain examples, the lower portion 114 of the handle 110 includes a T-channel 126 that is designed to connect to the lower handle mount 170 (shown in FIG. 5). The T-channel 126 includes a narrow opening 127 and a wide opening 128. The narrow opening 127 extends from the second end 113 upward toward the first end 111 on the second side 117. The wide opening 128 extends along the second end 113. The T-channel 126 enables vertical movement along the length L of the handle 110 while preventing movement that is transverse to the length L. In this way, the lower handle mount 170 is slidably secured to the handle 110 such that the handle 110 is able to slide in the upward and downward directions along the handle length L, but when the handle 110 is pulled in a lateral direction, the lower handle mount 170 is held tight to the T-channel 126 such that the lateral force on the handle 110 is transferred through the lower handle mount 170 to the door. The T-channel 126 extends from the second end 113 upward toward the first end 111. The lower handle mount 170 is insertable into the T-channel 126 at the wide opening 128 on the second end 113.

In certain examples, the grip portion 116 extends along at least a portion of the length L. In certain examples, the grip portion 116 extends the entirety of the length L. The grip portion 116 provides a position for a user's hand to engage the handle 110. In certain examples, the upper handle mount 118 and the lower handle mount 170 provide clearance between the grip portion 116 and the door such that the user's hand can access the second side 117. The grip portion 116 may have any number of different aesthetic features or features for improved grip.

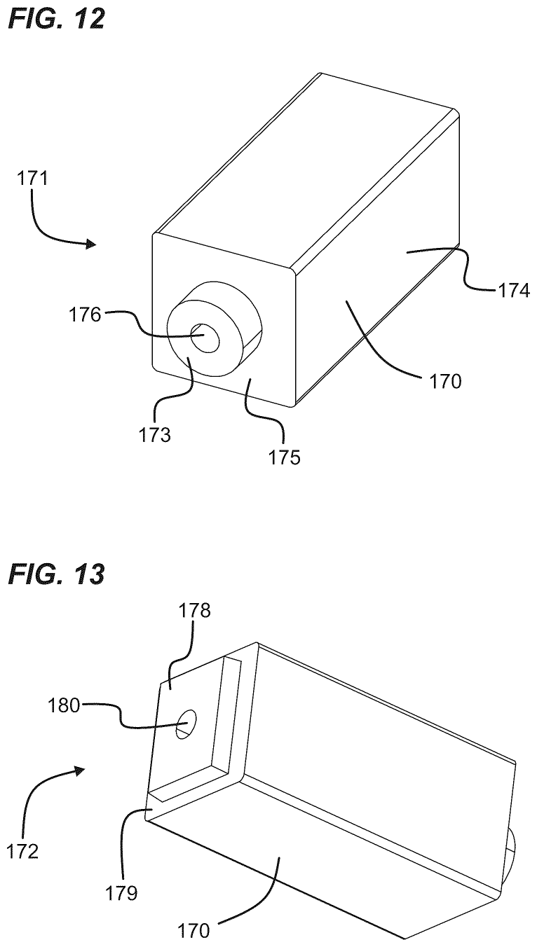

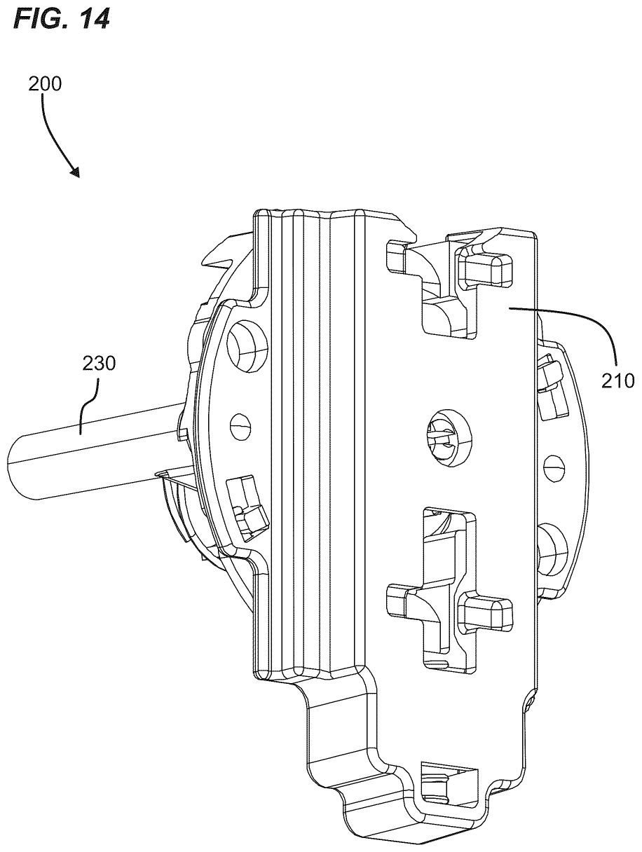

FIGS. 12 and 13 show an example lower handle mount 170. In certain examples, the lower handle mount 170 includes a handle side 171 and an escutcheon plate side 172. The handle side 171 includes a slide feature 173 that extends outward from a main body 174 and forms a shoulder 175 with the main body 174. The slide feature 173 is insertable in the narrow opening 127 of the handle 110 (shown in FIG. 11) while the shoulder 175 contacts the second side 117 (also shown in FIG. 11). The slide feature 173 includes a first threaded cavity 176 for a bolt 177 (shown in FIG. 5). A head of the bolt 177 has a diameter that is greater than a width of the narrow opening 127 such that the head of the bolt 177 is insertable into the wide opening 128 of the handle 110 (shown in FIG. 11) and is prevented from pulling through the narrow opening 127. In use, the handle 110 moves relative to the lower handle mount 170, and the T-channel 126 (shown in FIG. 11) provides clearance for the slide feature 173 during movement of the handle 110. The escutcheon plate side 172 includes an escutcheon plate engagement feature 178 that extends outward from the main body 174 and forms a shoulder 179 with the main body 174. The escutcheon plate engagement feature 178 includes a second threaded cavity 180 for a bolt 163 (shown in FIG. 5) that secures the lower handle mount 170 to the lower escutcheon plate 150 (shown in FIG. 5).

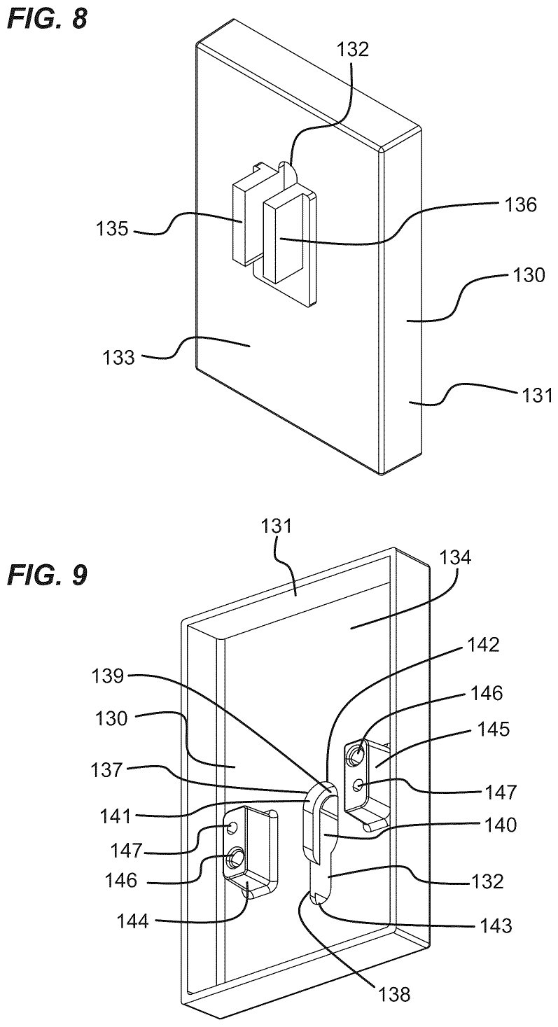

Turning to FIGS. 8 and 9, the upper escutcheon plate 130 is designed to mount to a face of a door and to enclose one side of the transmission assembly 200 (shown in FIG. 5). The upper escutcheon plate 130 includes a front face 133 and a rear face 134. The front face 133 faces outwardly from the door and engages with the handle 110 (shown in FIG. 5). The rear face 134 faces the door. In certain examples, the rear face 134 is recessed by a sidewall 131 that extends around the perimeter of the upper escutcheon plate 130. The upper escutcheon plate 130 includes first and second handle alignment features 135, 136. The first and second handle alignment features 135, 136 are designed to fit into the slide channel 120 (shown in FIG. 11) of the handle 110. In certain examples, the first and second handle alignment features 135, 136 form walls that extend laterally outward from the front face 133. The first and second handle alignment features 135, 136 are spaced apart to provide clearance for the handle slide pin 190 and the bolt 198 (both shown in FIG. 5).

In certain examples, a slot 132 is positioned between the first and second handle alignment features 135, 136 and provides an opening between the front face 133 and rear face 134. The handle slide pin 190 and the bolt 198 extend through the slot 132. The slot 132 includes an upper slot portion 137 and a lower slot portion 138. The upper slot portion 137 includes a shoulder 139 connecting a narrow region 140 and a wide region 141. The wide region 141 is sized to be at least as wide as a diameter of the head of the bolt 198. The narrow region 140 is sized to have a width less than the diameter of the head of the bolt 198 but at least as wide as a shaft of the bolt 198. In the assembled state, the bolt 198 is slidably secured to the upper escutcheon plate 130 such that an underside of the head of the bolt 198 runs along the shoulder 139 and the bolt 198 is prevented from being pulled away from the upper escutcheon plate 130 by the shoulder 139. The transition between the upper slot portion 137 and the lower slot portion 138 prevents the bolt 198 from traveling into the lower slot portion 138. The lower slot portion 138 has the same width as the narrow region 140. The lower slot portion 138 is designed for the handle slide pin 190 to extend through the lower slot portion 138. A top 142 of the slot 132 defines an upper limit for the travel of the bolt 198 and the handle slide pin 190 within the slot 132. A bottom 143 of the slot 132 defines a lower limit for the travel of the bolt 198 and the handle slide pin 190 within the slot 132.

In certain examples, the upper escutcheon plate 130 includes first and second transmission attachment features 144, 145. The first and second transmission attachment features 144, 145 extend from the rear face 134 toward the door to a maximum depth that matches the sidewall 131. The first and second transmission attachment features 144, 145 each include a first cavity 146 and a second cavity 147. In certain examples, the first cavities 146 are threaded for a fastener to secure the transmission assembly 200 to the upper escutcheon plate 130. In certain examples, the second cavities 147 are threaded for a fastener to secure the transmission assembly 200 to the upper escutcheon plate 130. In certain examples the first and/or second cavities 146, 147 connect to corresponding cavities in the transmission assembly 200 and secure an opposite escutcheon plate on an opposite side of the door.

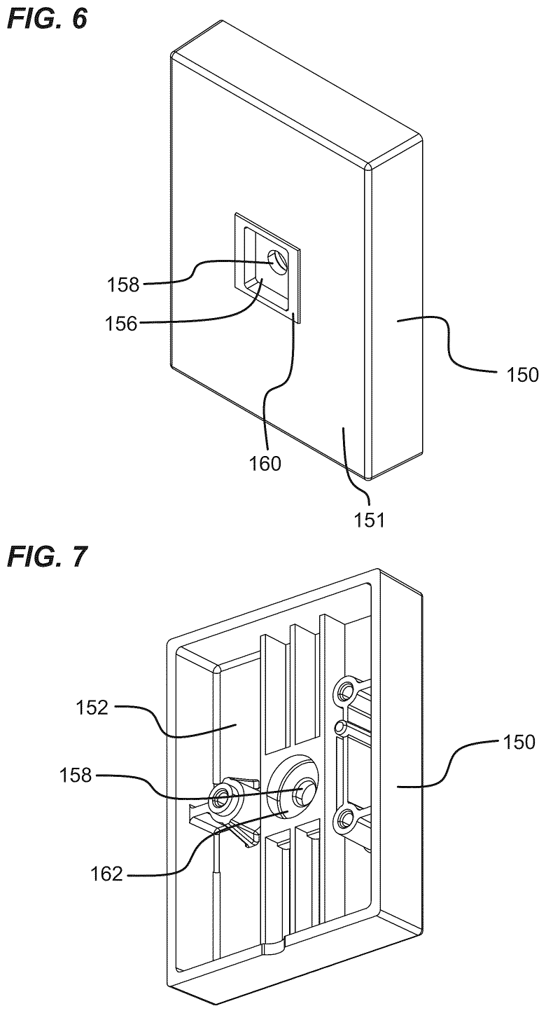

An example lower escutcheon plate 150 is shown in FIGS. 6 and 7. In certain examples, the lower escutcheon plate 150 has a front face 151 and a rear face 152. The front face 151 faces toward the handle 110 (shown in FIG. 5). The rear face 152 faces toward the face of the door. On the front face 151, the lower escutcheon plate 150 includes a recess 156 that is sized to receive the escutcheon plate engagement feature 178 (shown in FIG. 13). The lower escutcheon plate 150 includes an escutcheon cavity 158 that aligns with the second threaded cavity 180 of the lower handle mount 170 (both shown in FIG. 13). The escutcheon cavity 158 extends through the front face 151 and the rear face 152. In certain examples, the shoulder 179 (shown in FIG. 13) of the lower handle mount 170 seats on a contact feature 160 of the lower escutcheon plate 150. In certain examples, the rear face 152 of the lower escutcheon plate 150 includes a fastener recess 162 that is designed for the head of the bolt 163 (shown in FIG. 5), while the shaft continues through the escutcheon cavity 158 and eventually engages the second threaded cavity 180 of the lower handle mount 170.

In certain examples, the upper and lower escutcheon plates 130, 150 may be different portions of a single escutcheon plate. In certain examples, the lower handle mount 170 is part of the handle 110 like the upper handle mount 118 (shown in FIG. 10). In certain examples, the lower escutcheon plate 150 is adapted to accommodate sliding by the lower handle mount 170 like the upper escutcheon mount is adapted to accommodate sliding by the upper handle mount 118.

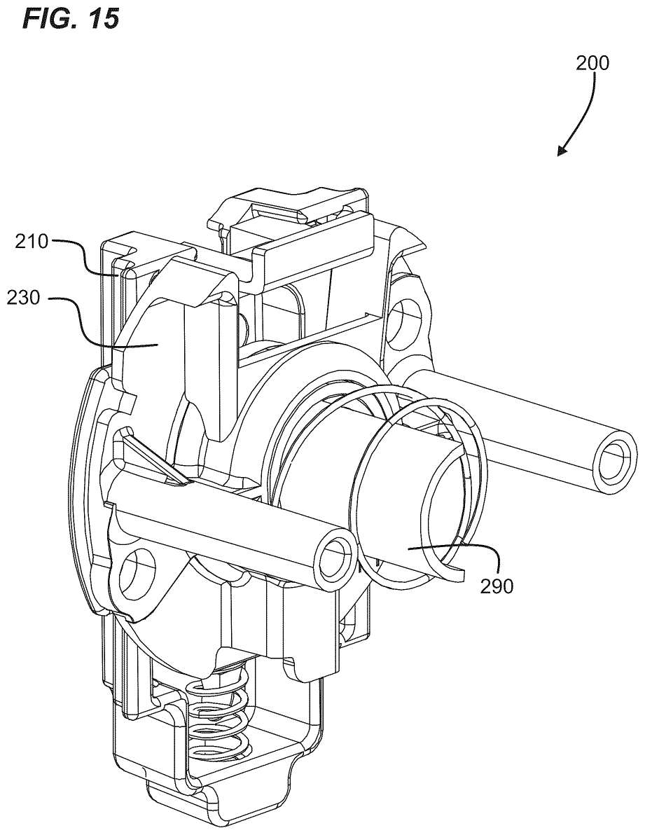

In certain examples, as shown in FIGS. 14-18, the transmission assembly 200 includes a front faceplate 210, a rear faceplate 230, a compression bracket 250, a latch pinion 260, a pinion pin 270, a driver rotator 280, and a latch driver 290.

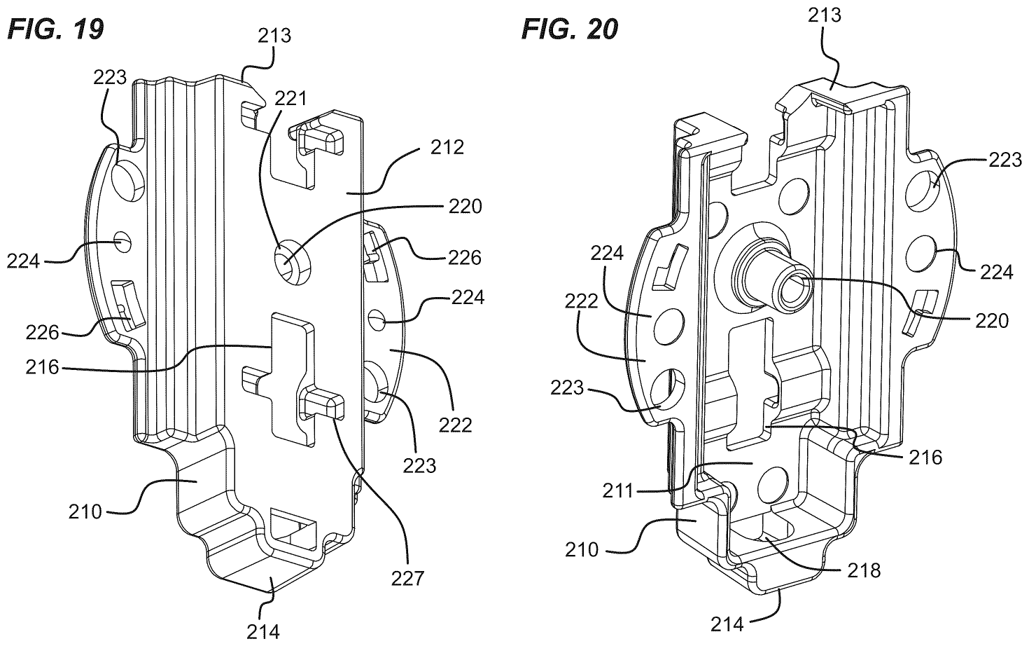

The front faceplate 210 is designed to be positioned against the upper escutcheon plate 130 (shown in FIG. 5) and house a portion of the transmission assembly 200. In certain examples, as shown in FIGS. 19 and 20, the front faceplate 210 has a front side 212 and a back side 211. The front side 212 contacts the upper escutcheon plate 130 (shown in FIG. 5). In certain examples, the front faceplate 210 has a first end 213 and a second end 214. The front faceplate 210 extends from the first end 213 to the second end 214 in the direction of travel of the handle slide pin 190 (shown in FIG. 5). In certain examples, the front faceplate 210 includes a handle pin slot 216 that provides clearance for the handle slide pin 190 to extend through the front faceplate 210. In certain examples, the handle pin slot 216 is elongated in the direction of travel for the handle slide pin 190, extending an intermediate distance between the first end 213 and the second end 214. The handle pin slot 216 has a similar width to the lower slot portion 138 of the slot 132 of the upper escutcheon plate 130 (all shown in FIG. 9) such that side-to-side movement of the handle slide pin 190 is prevented. In certain examples, the front faceplate 210 also includes a spring recess 218 positioned at the second end 214. The spring recess 218 is designed to retain a portion of a coil spring 228 (shown in FIG. 18). Other types of springs may be used instead of a coil spring 228. The spring recess 218 is positioned below the handle pin slot 216 such that the handle slide pin 190 extends above the coil spring 228.

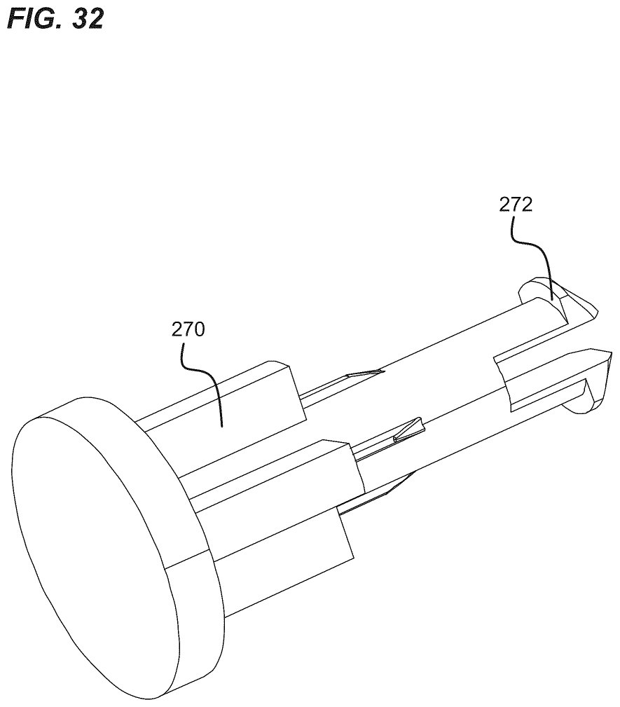

In certain examples, the front faceplate 210 includes a pinion retention cavity 220 that is designed to receive an end of the pinion pin 270 (shown in FIG. 18). The pinion retention cavity 220 includes a shoulder 221 on the front side 212 that is designed to engage a lip 272 on the pinion pin 270, as shown in FIG. 32. The front faceplate 210 includes two tabs 222 that connect to the first and second transmission attachment features 144, 145 (shown in FIG. 9) of the upper escutcheon plate 130. Each tab 222 includes first and second attachment cavities 223, 224 that correspond to the first and second cavities 146, 147.

In certain examples, the front faceplate 210 includes a faceplate attachment feature 226 that connects the front faceplate 210 to a corresponding attachment feature of the rear faceplate 230 (shown in FIG. 18). In certain examples, the front faceplate 210 includes the faceplate attachment feature 226 on each tab 222. In certain examples, the faceplate attachment feature 226 is a twist-latch. The front faceplate 210 also includes a transverse groove 227 defined on the front side 212 and across the handle pin slot 216. The transverse groove 227 may extend on both sides of the handle pin slot 216.

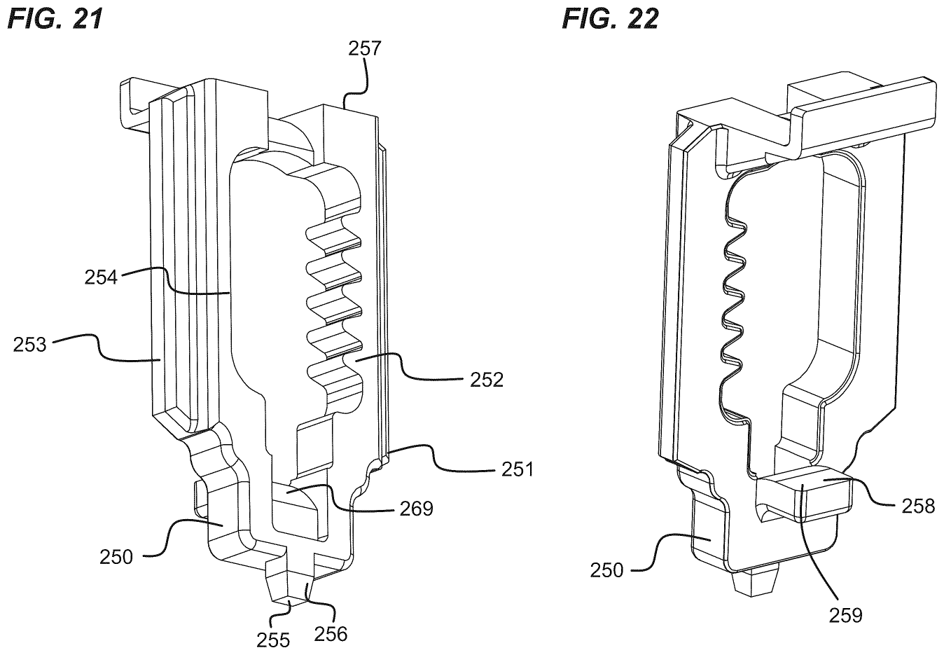

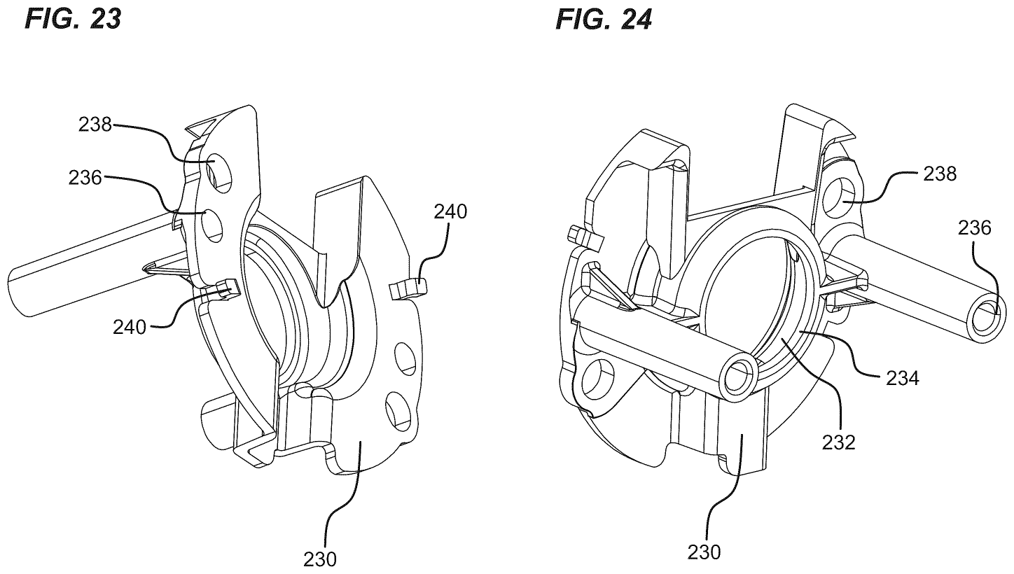

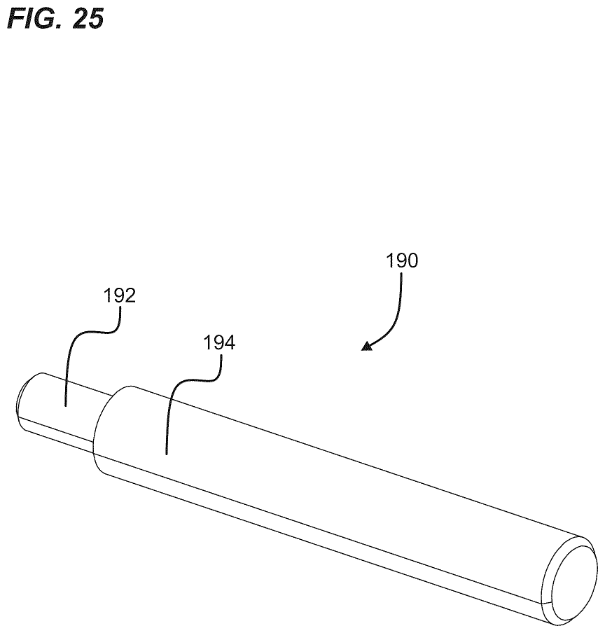

FIGS. 21-22 show an example compression bracket 250. The compression bracket 250 includes opposite first and second sides 251, 253 and opposite first and second ends 255, 257. In certain examples, the compression bracket 250 includes a rack 252. The rack 252 includes a plurality of teeth that are designed to interleave with teeth of the latch pinion 260 (shown in FIG. 18). The rack 252 extends along the first side 251 of the compression bracket 250 with the teeth forming a portion of an opening 254. The rack 252 extends in the slide direction of the handle slide pin 190 (shown in FIG. 5). In certain examples, the compression bracket 250 includes a spring leg 256 at the first end 255 of the compression bracket 250. The compression bracket 250 includes a slide pin contact surface 258. In certain examples, the slide pin contact surface 258 forms an elbow that extends outward from the opening 254. As shown in FIG. 25, the handle slide pin 190 includes a first width 192 and a second width 194. In certain examples, the first width 192 contacts the compression bracket 250 at a first portion 259 of the slide pin contact surface 258 and an edge of the second width 194 contacts a second portion 269 of the slide pin contact surface 258. The opening 254 provides clearance for the handle slide pin 190 and for the latch pinion 260. The handle slide pin 190 may also be referred to as a drive arm that enables operation of the handle to engage the and operate the compression bracket.

FIGS. 23-24 show an example rear faceplate 230. The rear faceplate 230, in combination with the front faceplate 210 (shown in FIG. 21-22) are designed to hold the transmission assembly 200 (shown in FIG. 18) together. In certain examples, the rear faceplate 230 includes a central opening 232 with an inward lip 234. The central opening 232 is designed to form a close fit with the driver rotator 280 (shown in FIG. 18). The inward lip 234 is designed to hold the driver rotator 280 within the transmission assembly 200. In certain examples, the rear faceplate 230 includes an elongated cavity 236 that corresponds to and aligns with the second attachment cavity 224 (shown in FIGS. 21-22) of the front faceplate 210. In certain examples, the rear faceplate 230 includes an attachment opening 238 that corresponds to and aligns with the first attachment cavity 223 (shown in FIGS. 21-22) of the front faceplate 210. In certain examples, the rear faceplate 230 includes a rear attachment feature 240 that corresponds to and engages the attachment feature 226 (shown in FIGS. 21-22) of the front faceplate 210. In certain examples, the rear faceplate 230 includes two rear attachment features 240 positioned on opposite sides of the rear faceplate 230. When the rear attachment features 240 engage the attachment features 226 of the front faceplate 210, the transmission assembly 200 is held together.

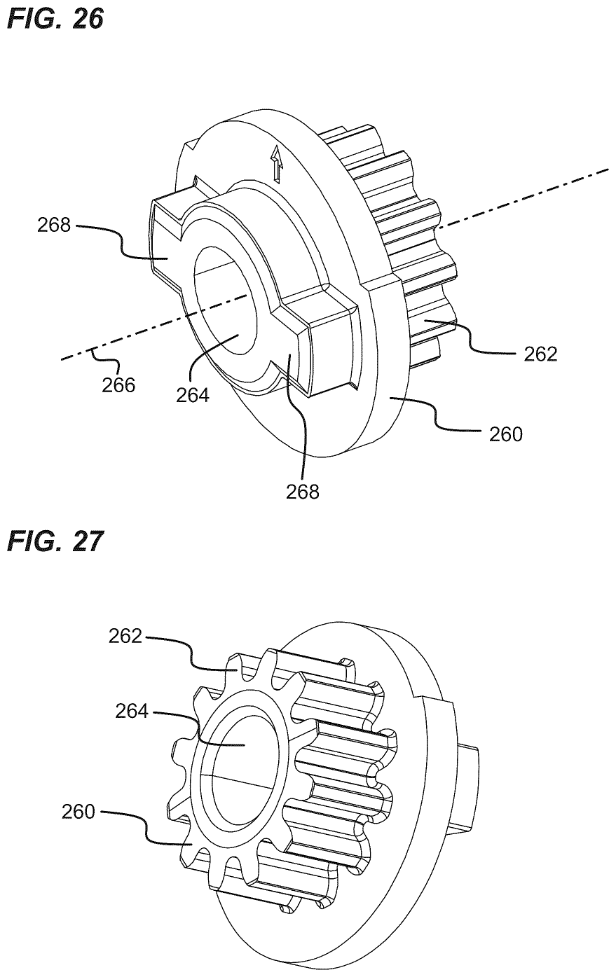

FIGS. 26-27 show an example latch pinion 260. In certain examples, the latch pinion 260 includes a gear portion 262 that surrounds a central cavity 264. The central cavity 264 extends axially through the latch pinion 260 about a rotation axis 266. The latch pinion 260 further includes two rotation tabs 268 that are designed to engage with the driver rotator 280 (shown in FIG. 18). The latch pinion 260 is held within the opening 254 of the compression bracket 250 (shown in FIGS. 21-22) by the pinion pin 270 (shown in FIG. 18), which extends through the central cavity 264 and connects the pinion pin 270 to the front faceplate 210 (shown in FIGS. 19-20). The latch pinion 260 is able to rotate about the rotation axis 266 and about the pinion pin 270. The gear portion 262 engages the teeth of the rack 252 (shown in FIGS. 21-22) such that when the handle slide pin 190 (shown in FIG. 5) moves the compression bracket 250, the latch pinion 260 rotates about the rotation axis 266.

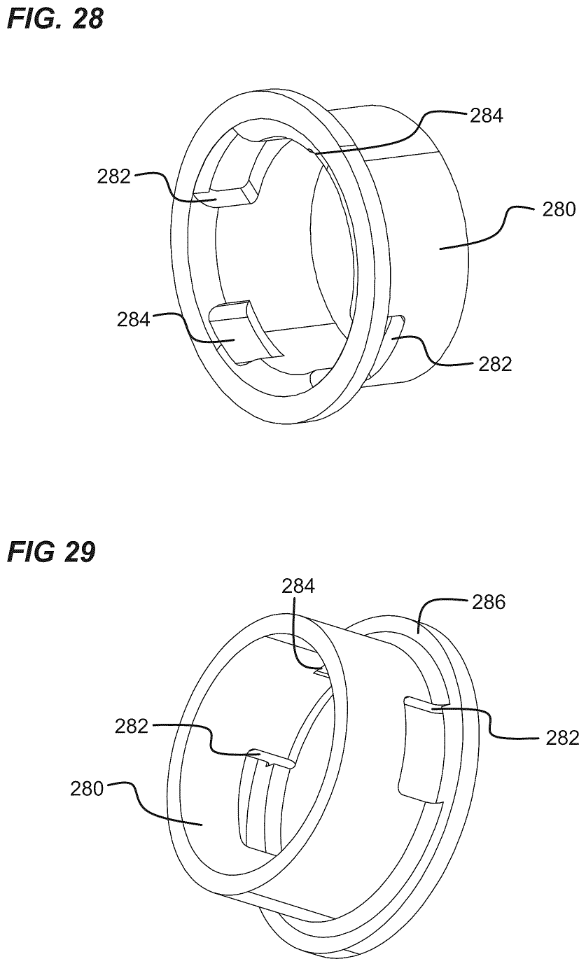

FIGS. 28-29 show an example driver rotator 280 that bridges the latch pinion 260 and the latch driver 290 (both shown in FIG. 18). In certain examples, the driver rotator 280 includes pinion engagement openings 282 that correspond to and engage with the rotation tabs 268 (shown in FIGS. 26-27) of the latch pinion 260. When the latch pinion 260 rotates, the driver rotator 280 also rotates. The driver rotator 280 also includes latch driver engagement slots 284 that are designed to engage the latch driver 290 such that rotation of the latch pinion 260 causes equal rotation of the latch driver 290. In certain examples, the driver rotator 280 includes a retention lip 286 that engages the inward lip 234 of the rear faceplate 230 (shown in FIGS. 23-24) and prevents the driver rotator 280 from detaching from the transmission assembly 200 (shown in FIG. 18). In certain examples, a spring 288 (shown in FIG. 18) is positioned between the driver rotator 280 and the rear faceplate 230. In certain examples, the spring 288 is a torsion spring that biases the driver rotator 280 toward a latched state.

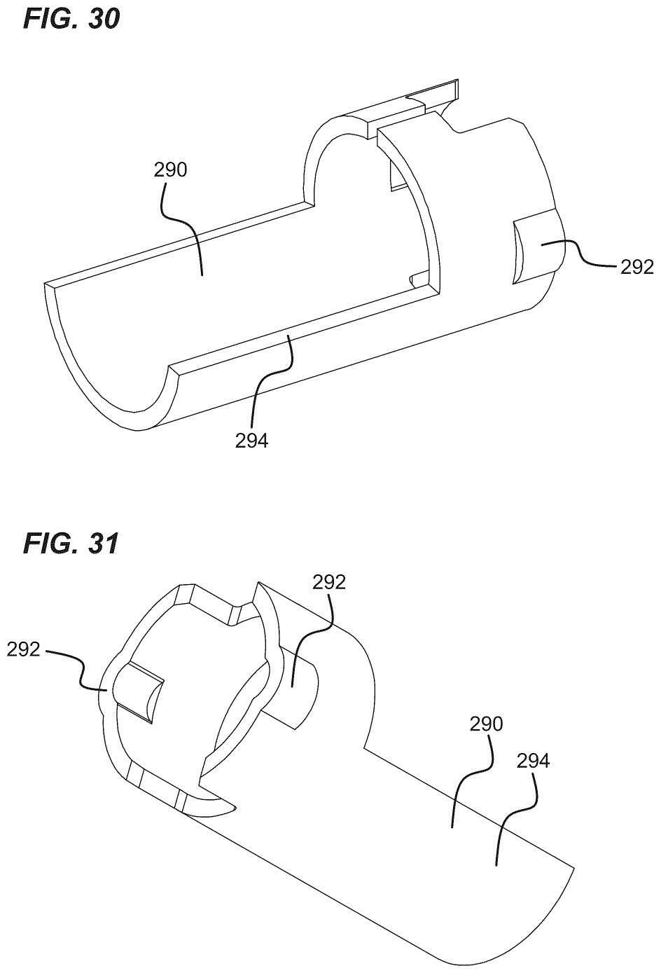

FIGS. 30-31 show an example latch driver 290. In certain examples, the latch driver 290 is used to move a latch assembly in a door and rotation of the latch driver 290 causes extension and retraction of a latch bolt therewith. The latch driver 290 is held within the transmission assembly 200 (shown in FIG. 18) by two driver attachment features 292 that correspond to and insert into the latch driver engagement slots 284 of the driver rotator 280 (shown in FIGS. 28-29). The latch driver 290 includes an arm 294 that forms a c-shape around the rotation axis 266 (shown in FIG. 26). The arm 294 contacts and engages with the latch assembly (not shown) for the door.

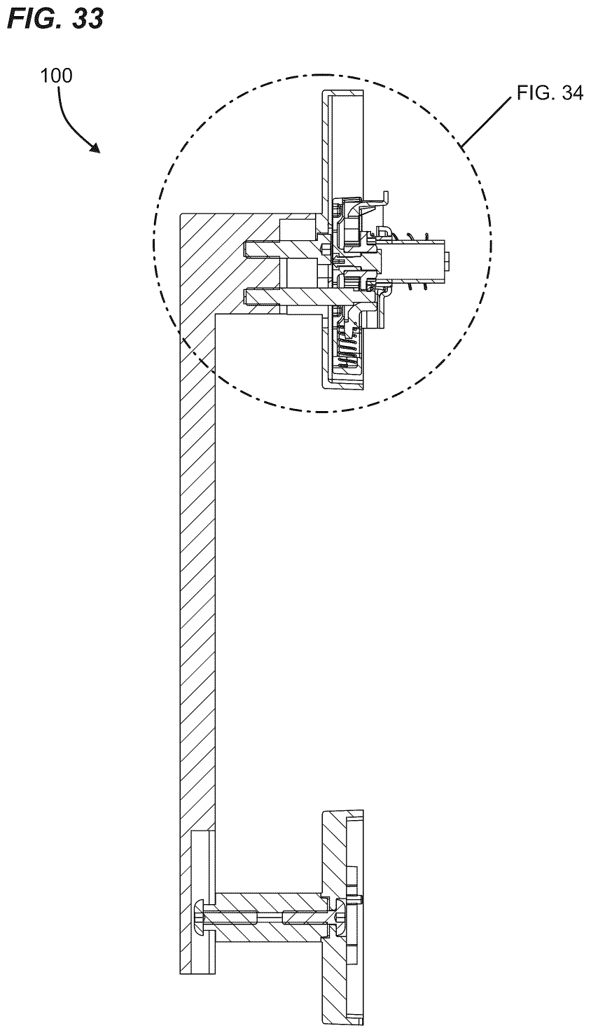

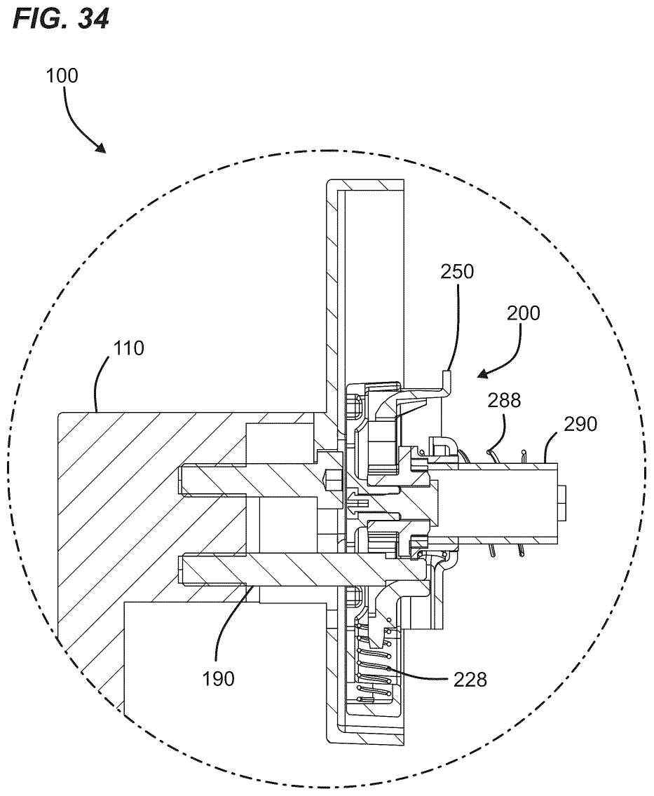

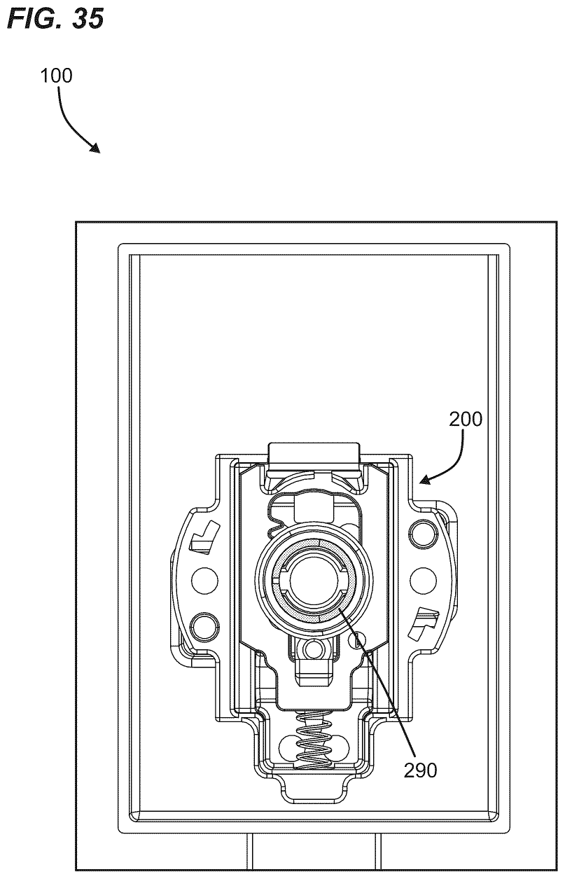

FIGS. 33-34 show a cross section of the handle assembly 100 when the handle assembly 100 is in a latched configuration. The handle assembly 100 is biased toward the latched configuration by the spring 228 of the transmission assembly 200 and, in certain examples, the biasing is assisted by the spring 288. When the handle assembly 100 is in the latched configuration, the handle 110, handle slide pin 190, compression bracket 250, latch pinion 260 (shown in FIGS. 26-27), driver rotator 280 (shown in FIGS. 28-29), and latch driver 290 are all in a first, latched position. FIG. 35 shows a focused rear view of the handle assembly 100 in the latched state, where the first, latched position of the latch driver 290 of the transmission assembly 200 is visible.

Referring concurrently to FIGS. 33-35, when a force is applied to the handle 110 in a slide direction, the handle 110 moves toward a second, unlatched position. Movement of the handle 110 causes movement of the handle slide pin 190 which presses against the slide pin contact surface 258 (shown in FIGS. 21-22) of the compression bracket 250. In turn, the compression bracket 250 moves toward a second, unlatched position and compresses the spring 228. The linear movement of the handle 110, handle slide pin 190, and compression bracket 250 causes rotational movement of the latch pinion 260 about the rotation axis 266 (shown in FIG. 26). Rotation in the latch pinion 260 causes rotation of the driver rotator 280 and the latch driver 290.

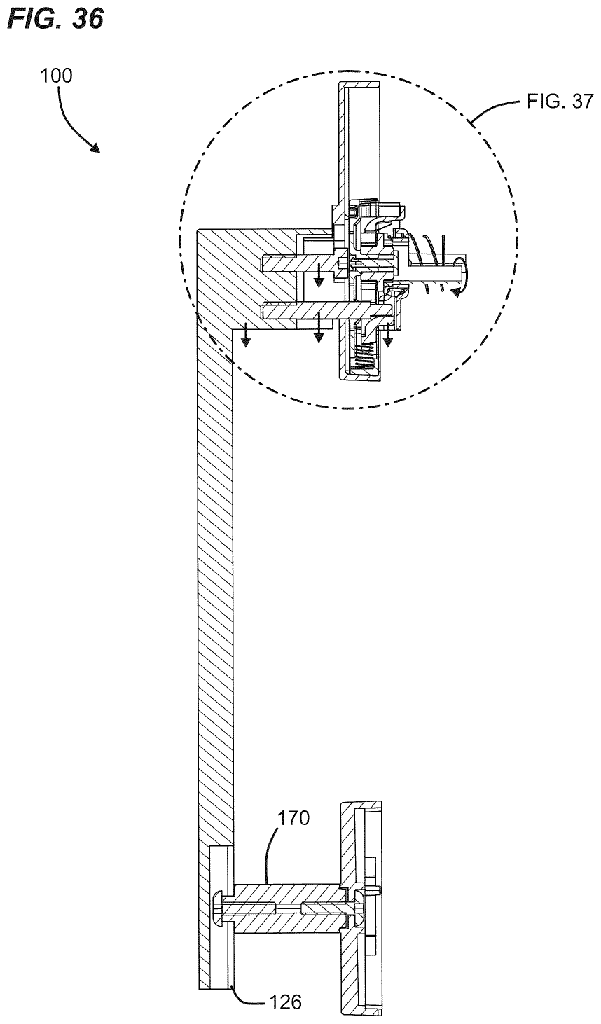

FIGS. 36-38 show the handle assembly 100 in an unlatched configuration. When the handle assembly 100 is in the unlatched configuration, the handle 110, handle slide pin 190, compression bracket 250, latch pinion 260 (shown in FIGS. 26-27), driver rotator 280 (shown in FIGS. 28-29), and latch driver 290 are all in the second, unlatched position. Movement of the handle 110 also causes relative movement between the lower handle mount 170 and the handle 110. The T-channel 126 of the handle 110 slides downward while the lower handle mount 170 remains fixed.

In certain examples, travel of the handle slide pin 190 is limited by the slot 132 of the upper escutcheon plate 130 (shown in FIG. 9). In certain examples, the handle slide pin 190 reaches the second, unlatched position when the handle slide pin 190 contacts the bottom 143 (shown in FIG. 9) of the slot 132.

While the figures and above description show the handle 110 moving in a vertical direction, it should be noted that the handle 110 may slide linearly along a horizontal axis or any other axis. In certain examples, the handle 110 is slidable about an axis that is parallel to the face of the door. In other examples, the slide direction may be any direction with at least a portion of the handle 110 movement being parallel to the face of the door. Similarly, the relationship between the various components of the handle assembly 100, including the upper and lower handle mounts 118, 170, the upper and lower escutcheon plates 130, 150, and the transmission assembly 200 may be adapted to accommodate the different possible directions of linear motion of the handle 110.

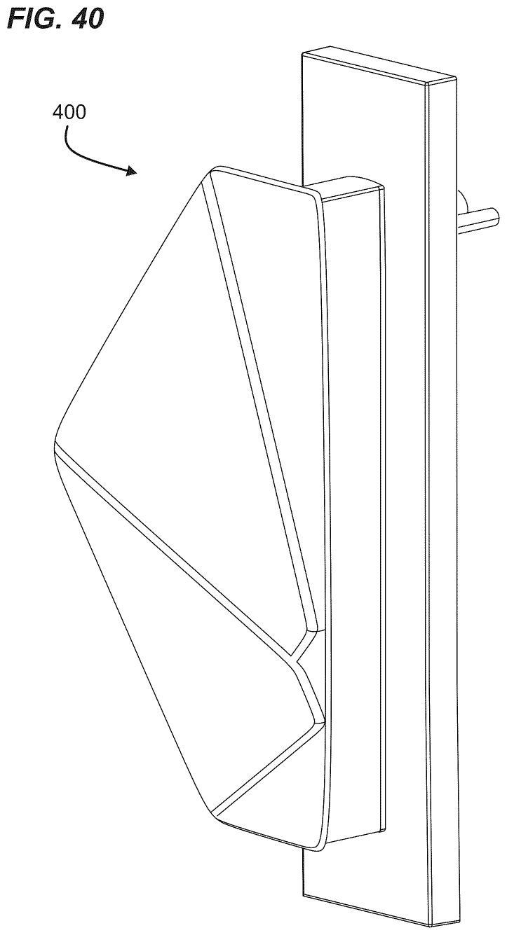

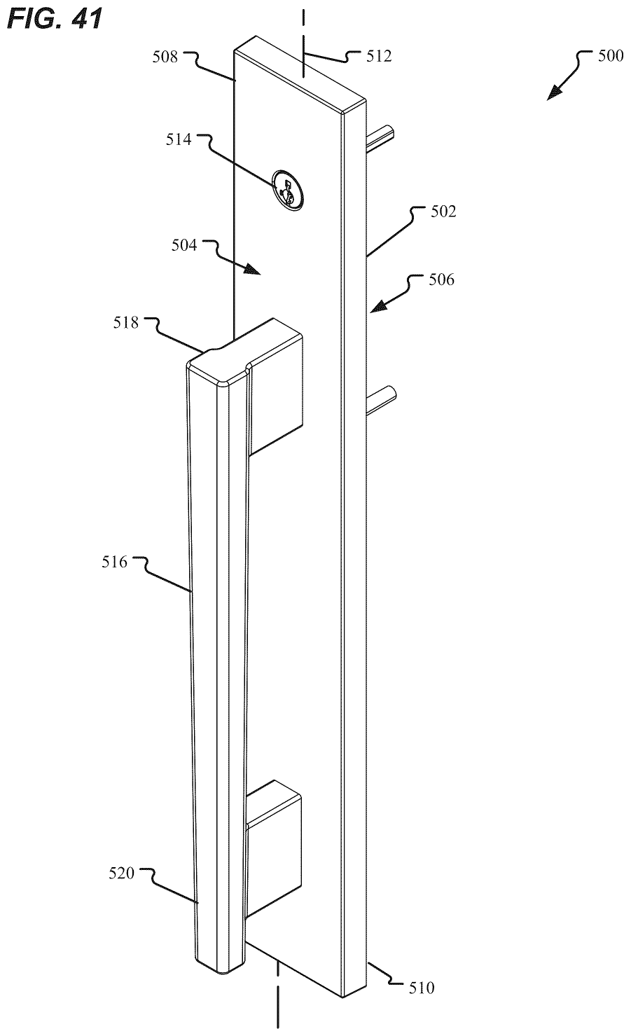

FIGS. 39-40 show variations of handles that share many of the characteristics of the handle assembly 100 as described above. In certain examples, the handle assemblies 300 and 400 are aesthetic variations of the handle assembly 100 such that handles of the handle assemblies 300, 400 could be used in place of handle 110 on the handle assembly 100. As shown in handle assembly 400, in certain examples, the upper and lower escutcheon plates 130, 150 may be replaced by a single escutcheon plate.

In all of the handle assemblies described herein, the handle is slidably mounted on the one or more escutcheon plates so that the handle longitudinally slides (e.g., in a vertical direction) relative to the one or more escutcheon plates. The handle does not pivot or horizontally slide relative to the one or more escutcheon plates. Rather the handle slides along a vertical plane that is parallel to the front face of the one or more escutcheon plates. In an aspect, the handle mounts of the handle are slidably engaged with the one or more escutcheon plates and slidably move relative thereto in order to operate the handleset. In examples, both the upper and lower handle mounts are slidably engaged with the escutcheon so that the entire handle slides. In other examples, at least the upper handle mount is slidably engaged, however, the lower handle mount may still slide relative to the escutcheon plates. In still other examples, the handle may slide relative to the lower handle mount as required or desired and so that a portion of the entire handle slides.

FIG. 41 is a front perspective view of another example of a handle assembly 500. In this example, the handle assembly 500 includes a single escutcheon plate 502 having a front face 504 and an opposite rear face 506. The rear face 506 is configured to mount on a face of a door. The escutcheon plate 502 also includes a first end 508 and a second end 510 defining a longitudinal axis 512. It is appreciated that the escutcheon plate 502 may be separated into two or more plates as required or desired.

Proximate the first end 508 of the escutcheon plate 502 the handle assembly 500 includes a key cylinder 514 configured to operate a corresponding deadbolt assembly (not shown) for the door. In aspects, the handle assembly 500 may not include the key cylinder 514 as required or desired.

The handle assembly 500 also includes a handle 516 coupled to the front face 504 of the escutcheon plate 502. The handle 516 is configured to slide relative to the escutcheon plate 502 and along the direction of the longitudinal axis 512 so as to operate a corresponding latch assembly (not shown) for the door. The handle 516 includes a first end 518 and an opposite second end 520 such that the handle 516 is elongated along the longitudinal axis 512. In the example, both the first end 518 and the second end 520 of the handle 516 are slidingly coupled to the front face 504 of the escutcheon plate.

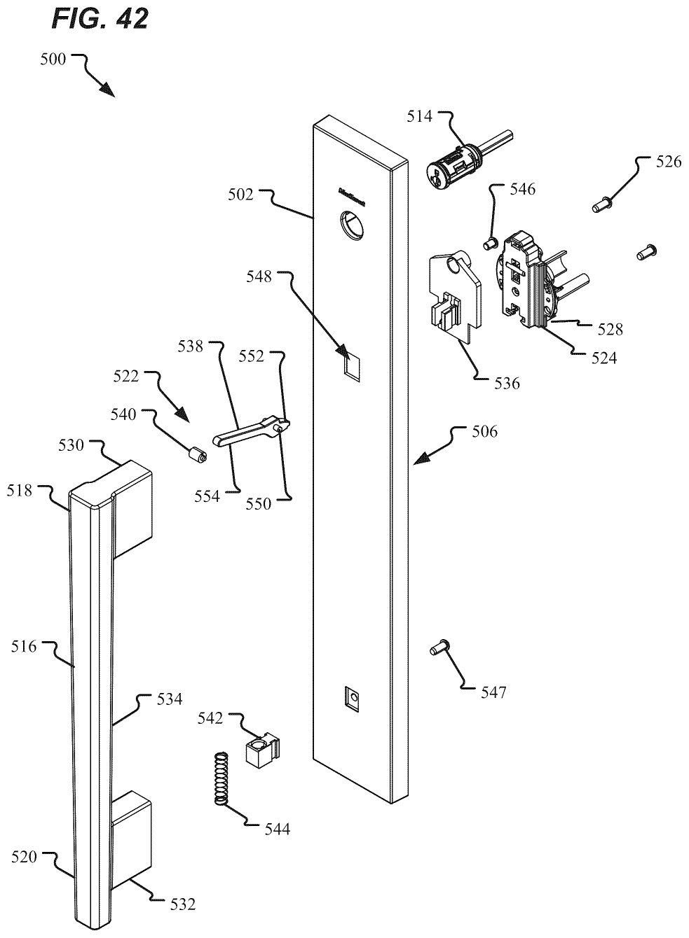

FIG. 42 is an exploded front perspective view of the handle assembly 500. The handle assembly 500 includes the escutcheon plate 502 and the handle 516. A drive assembly 522 operationally couples the handle 516 to a transmission assembly 524 that couples to a corresponding latch assembly (not shown) for extending and retracting a latch bolt from the door. The handle assembly 500 may also include the key cylinder 514 for operating a corresponding deadbolt assembly (not shown). The transmission assembly 524 is coupled to the rear face 506 of the escutcheon plate 502 via fasteners 526 and is the same assembly described above in FIGS. 14-24 and 26-32. In this example, however, the transmission assembly 524 is rotated 180 degrees and with a compression bracket 528 disposed at a bottom end of the transmission assembly 524.

The handle 516 includes a first handle mount 530 disposed at the first end 518 of the handle 516, a second handle mount 532 disposed at the second end 520 of the handle 516, and a grip portion 534 extending between the first and second handle mounts 530, 532. The grip portion 534 is elongated along the longitudinal axis 512 (shown in FIG. 41) and the first and second handle mounts 530, 532 extend from the grip portion 534 in a transverse direction orthogonal to the longitudinal axis 512.

The drive assembly 522 includes an alignment plate 536, a drive arm 538, and a roller 540 disposed at the first handle mount 530 of the handle 516. The drive assembly 522 also includes a fixed handle mount 542 and a biasing member 544 (e.g., a compression spring) disposed at the second handle mount 532. The alignment plate 536 is coupled to the rear face 506 of the escutcheon plate 502 via a fastener 546. A portion of the alignment plate 536 extends through an opening 548 defined through the escutcheon plate 502. The alignment plate 536 pivotably supports the drive arm 538 via a pivot pin 550 captured between the alignment plate 536 and the transmission assembly 524 at the rear face 506 of the escutcheon plate 502. For example, the pivot pin 550 is disposed within the transverse groove 227 (shown in FIG. 19).

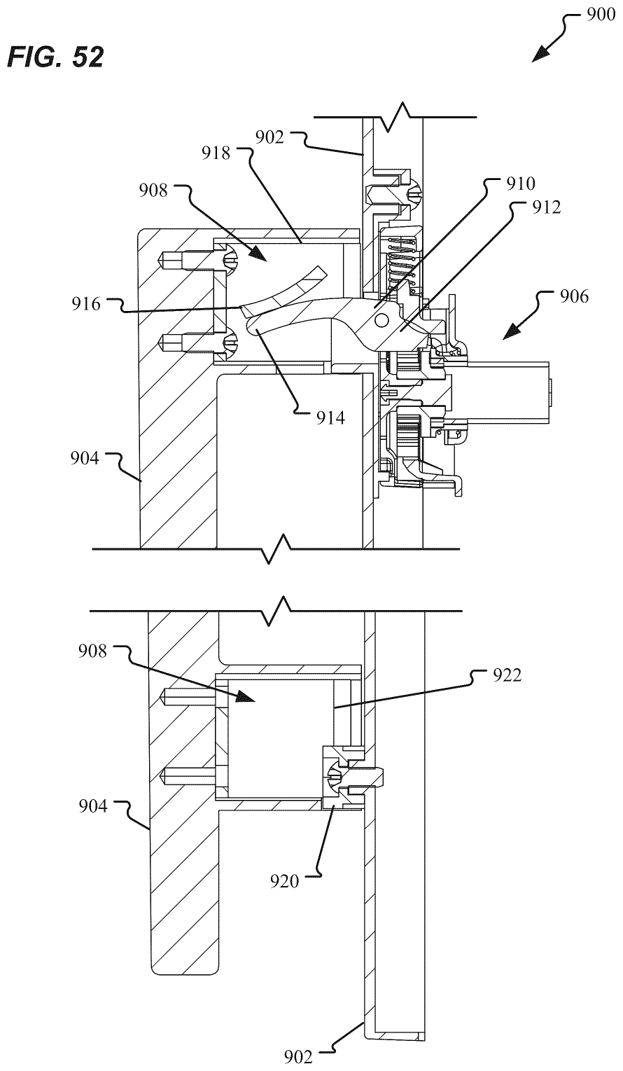

The drive arm 538 extends through the opening 548 of the escutcheon plate 502 and has a first end 552 engaged with the compression bracket 528 of the transmission assembly 524 and an opposite second end 554 disposed within the first handle mount 530 of the handle 516. The pivot pin 550 is disposed between the first and second ends 552, 554. In the example, the second end 554 of the drive arm 538 engages the roller 540. The roller 540 reduces friction within the drive assembly 522 during movement of the handle 516. In other examples, the first handle mount 530 may include camming arc surfaces (e.g., the example shown in FIG. 52) for the second end 554 of the drive arm 538 for reducing friction within drive assembly 522. The fixed handle mount 542 is secured to the escutcheon plate 502 via a fastener 547 extending from the rear face 506.

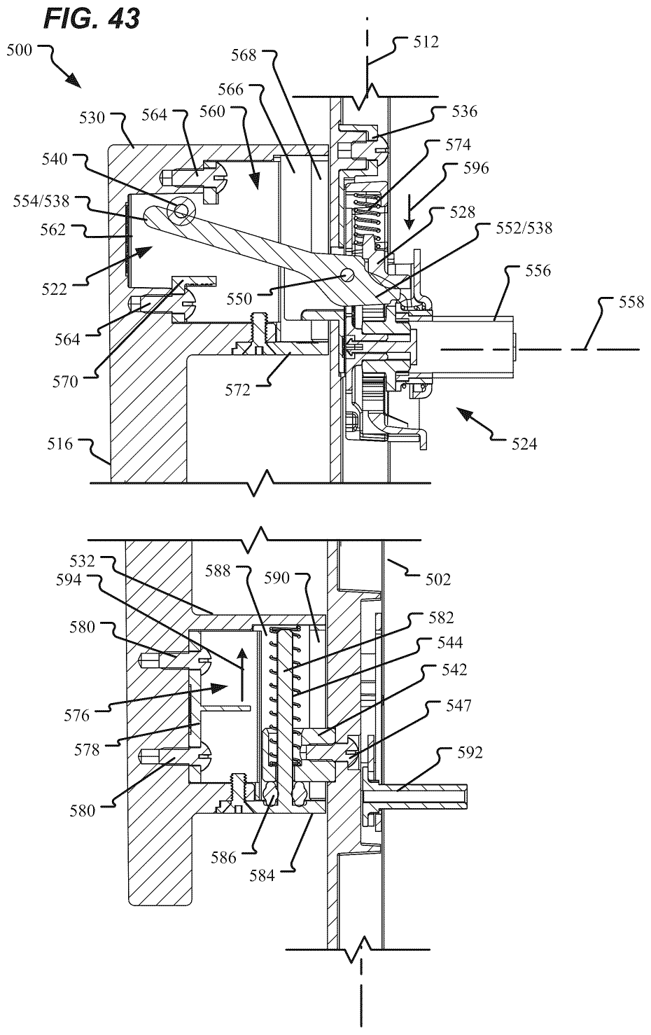

FIG. 43 is a cross-sectional view of the handle assembly of FIG. 41 in a latched configuration. In the latched configuration, the handle 516 is disposed in a latched position relative to the escutcheon plate 502. The latched position of the handle 516 is in an upward direction relative to the longitudinal axis 512 of the escutcheon plate 502. When the handle 516 is in the latched position, the drive assembly 522 is positioned so that the transmission assembly 524 rotates a latch driver 556 around a rotational axis 558 and the corresponding latch assembly (not shown) has its latch extended. The rotational axis 558 is orthogonal to the longitudinal axis 512.

The first handle mount 530 of the handle 516 is elongated along the longitudinal axis 512 and defines a first interior cavity 560 that receives at least a portion of the drive assembly 522. A first guide liner 562 is shaped and sized to fit within the first interior cavity 560 and is secured within via one or more fasteners 564. The first guide liner 562 is configured to support the roller 540 and allow the second end 554 of the drive arm 538 to pivot therein. The first guide liner 562 also defines a longitudinal channel 566 and an adjacent longitudinal rib 568 configured to engage with the alignment plate 536 to allow longitudinal sliding movement and preventing the handle 516 from being pulled out from the escutcheon plate 502. In the example, the second end 554 of the drive arm 538 is completely disposed within the first interior cavity 560 of the first handle mount 530 of the handle 516. The first guide liner 562 also includes a rotation stop 570 for the drive arm 538. A first cover 572 is used to enclose the drive assembly 522 and the first guide liner 562 within the first handle mount 530 of the handle 516.

In the latched configuration of the handle assembly 500, the first end 552 of the drive arm 538 is disposed below the second end 554 and relative to the pivot pin 550. This position of the drive arm 538 enables the compression bracket 528 of the transmission assembly 524 to be biased in a downward direction 296 relative to the longitudinal axis 512 and via a biasing member 574.

The second handle mount 532 of the handle 516 is also elongated along the longitudinal axis 512 and defines a second interior cavity 576 that receives at least a portion of the drive assembly 522. A second guide liner 578 is shaped and sized to fit within the second interior cavity 576 and is secured within via one or more fasteners 580. The second guide liner 578 houses a spring support 582 extending along the longitudinal axis 512 and disposed within the biasing member 544 that is disposed within the second handle mount 532. The spring support 582 is configured to support the compression spring forming the biasing member 544 and is also slidingly received at least partially within the fixed handle mount 542. The biasing member 544 extends between the fixed handle mount 542 and the interior surface of the second interior cavity 576 of the second handle mount 532.

The fixed handle mount 542 is secured to the escutcheon plate 502 via the fastener 547. A second cover 584 is used to enclose the drive assembly 522 and the second guide liner 578 within the second handle mount 532 of the handle 516. In the example, the spring support 582 may include a resilient bumper 586 at the bottom end. The second guide liner 578 also defines a longitudinal channel 588 and an adjacent longitudinal rib 590 configured to engage with the fixed handle mount 542 to allow longitudinal siding movement and preventing the handle 516 from being pulled out from the escutcheon plate 502.

The handle assembly 500 may also include an adjustable pull mounting mechanism 592 coupled to the rear face 506 (shown in FIG. 41) of the escutcheon plate 502 and opposite of the second handle mount 532. The adjustable pull mounting mechanism 592 is described in U.S. Pat. No. 11,105,118 that is incorporated by reference herein in its entirety.

In the latched configuration of the handle assembly 500, the biasing member 544 directly biases the handle 516 towards the latched position and in a direction 594 that is upwards along the longitudinal axis 512 and as illustrated in FIG. 43. Accordingly, the spring force of the biasing member 544 is sufficient to hold the weight of the handle 516 in the latched position and automatically return the handle 516 to the latched position. The biasing member 574 within the transmission assembly 524 also indirectly biases the handle 516 towards the latched position. The biasing member 574, however, biases the compression bracket 528 in a direction 596 that is downwards along the longitudinal axis 512 and as illustrated in FIG. 43. But with the pivoting orientation of the drive arm 538, this biasing direction also facilitates holding the handle 516 in the latched position and automatically returning the handle 516 towards the latched position.

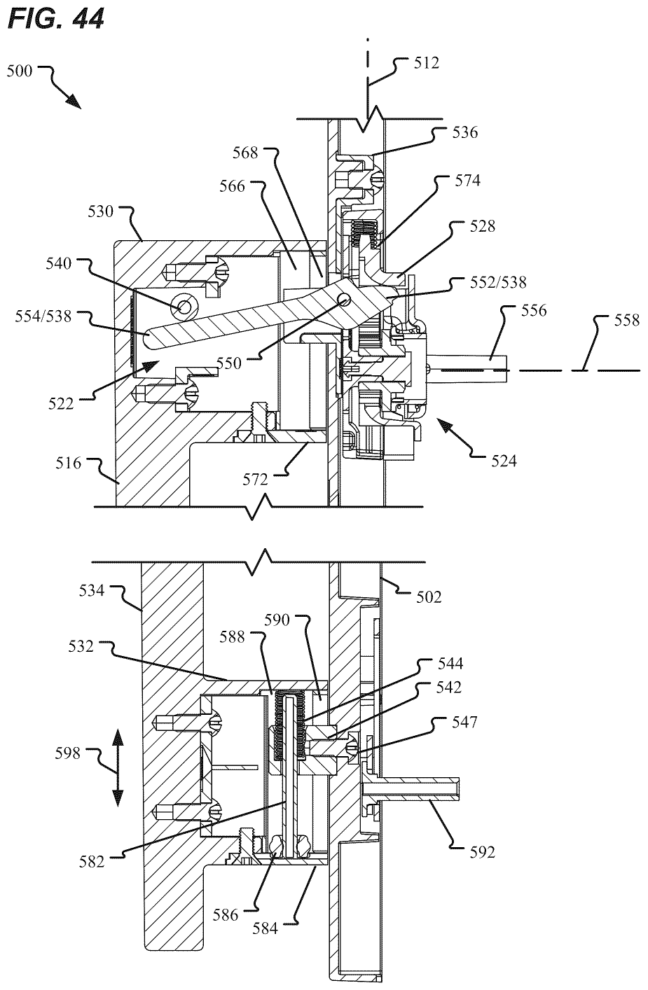

FIG. 44 is a cross-sectional view of the handle assembly 500 of FIG. 41 in a unlatched configuration. Certain components are described above, and thus, are not necessarily described further. In the unlatched configuration, the handle 516 is disposed in an unlatched position relative to the escutcheon plate 502. The unlatched position of the handle 516 is in a downward direction relative to the longitudinal axis 512 of the escutcheon plate 502. When the handle 516 is in the unlatched position, the drive assembly 522 is positioned so that the transmission assembly 524 rotates the latch driver 556 around the rotational axis 558 and the corresponding latch assembly (not shown) has its latch retracted.

In the example, the first and second handle mounts 530, 532 extend from the grip portion 534 in a direction parallel to the rotational axis 558. The first and second handle mounts 530, 532 are also elongated in a direction parallel to the longitudinal axis 512 so as to enable the handle 516 to slide relative to the escutcheon plate 502. The handle 516 is configured to slide a longitudinal distance 598 between the latched and unlatched positions. As such, both of the first and second handle mounts 530, 532 are elongated in the longitudinal axis direction with an elongated length that is greater than the sliding distance 598 of the handle 516. This configuration enables the components of the drive assembly 522 to be at least partially housed within the handle 516. In the example, the longitudinal length of the first and second handle mounts 530, 532 are equal. In other examples, the first handle mount 530 may have a different longitudinal length than the second handle mount 532.

In operation, a user manually slides the handle 516 relative to the escutcheon plate 502 and towards the unlatched position. Upon moving the handle 516 to the unlatched position, the drive arm 538 is pivoted so that the second end 554 is disposed below the first end 552 and relative to the pivot pin 550. This pivoting movement of the drive arm 538 lifts the compression bracket 528 and overcomes the biasing force of the biasing member 574 of the transmission assembly 524 thereby rotating the latch driver 556 and retracting the corresponding latch bolt.

Additionally, when the handle 516 slides along the longitudinal axis 512 towards the unlatched position, the second handle mount 532 slides relative to the fixed handle mount 542 extending from the front face of the escutcheon plate 502. This sliding movement overcomes the biasing force of the biasing member 544 and compressing the spring. When the user releases the handle 516 from the unlatched position, the biasing members 544, 574 automatically return the handle 516 to the latched position (shown in FIG. 43) and the handle assembly 500 to the latched configuration thereby extending the corresponding latch bolt.

In the example, the pivot pin 550 for the drive arm 538 defines a pivot axis that is orthogonal to both the longitudinal axis 512 and the rotational axis 558. Additionally, the longitudinal direction of movement of the handle 516 between the latched and unlatched configurations is opposite of the longitudinal direction of movement of the compression bracket 528 of the transmission assembly 524.

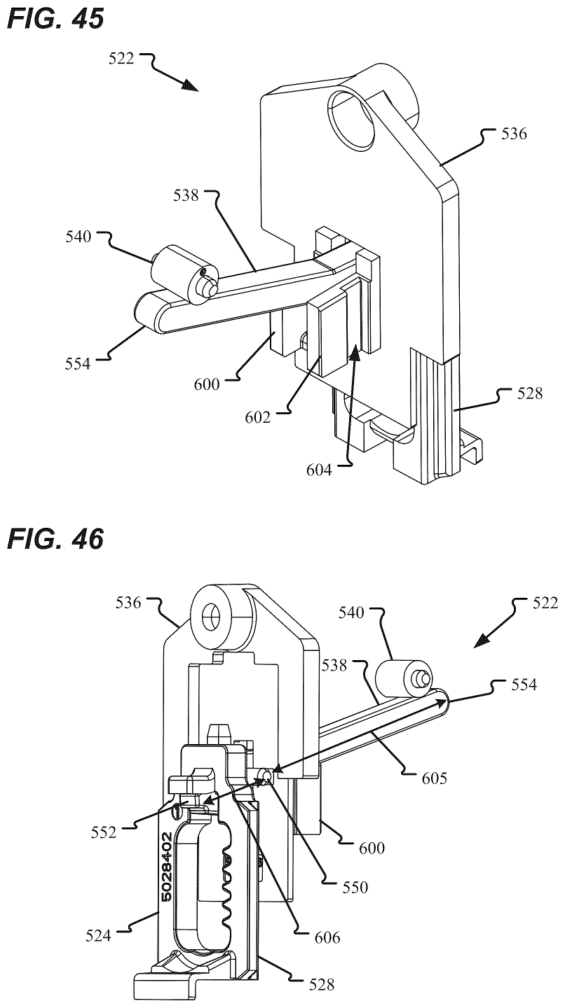

FIGS. 45-46 are perspective views of the portion of the drive assembly 522 disposed at the first handle mount 530 (shown in FIGS. 43 and 44). The alignment plate 536 includes a pair of alignment guides 600, 602 extending therefrom. The alignment guides 600, 602 extend through the opening 548 of the escutcheon plate 502 (both shown in FIG. 42) and are received within the first handle mount 530. The outside surfaces of the alignment guides 600, 602 define a longitudinal channel 604 that is shaped and sized to receive the longitudinal rib 568 of the first guide liner 562 (both shown in FIG. 43). Additionally, the distal end of the outer surfaces of the alignment guides 600, 602 are received within the longitudinal channel 566 (shown in FIG. 43) of the first guide liner 562. The engagement between the alignment guides 600, 602 and the first guide liner 562 facilitate the sliding movement of the handle 516 (shown in FIG. 43) relative to the escutcheon plate 502 and restricts the handle 516 from being pulled outward from the escutcheon plate 502.

The alignment guides 600, 602 are spaced apart from one another so that the drive arm 538 extends through the alignment plate 536 and can pivot relative thereto. The second end 554 of the drive arm 538 projects from the alignment guides 600, 602 and engages with the roller 540. The pivot pin 550 is disposed behind the alignment plate 536 relative to the second end 554 of the drive arm 538 and is captured within a corresponding groove via the transmission assembly 524. As illustrated in FIGS. 45 and 46, only the compression bracket 528 of the transmission assembly 524 is shown. The drive arm 538 has a length 605 defined between the second end 554 and the pivot pin 550 that is longer than a length 606 defined between the first end 552 and the pivot pin 550. The first end 552 of the drive arm 538 is directly engaged with the compression bracket 528 so that pivoting movement of the drive arm 538 corresponds to linear movement of the compression bracket 528 and as described herein.

The alignment plate 536 has a planar first side that the alignment guides 600, 602 extend from and an opposite second side with a recessed cavity. The planar first side is configured to be mounted against the rear face of the escutcheon plate 502. The transmission assembly 524 is at least partially mounted within the recessed cavity of the alignment plate 536.

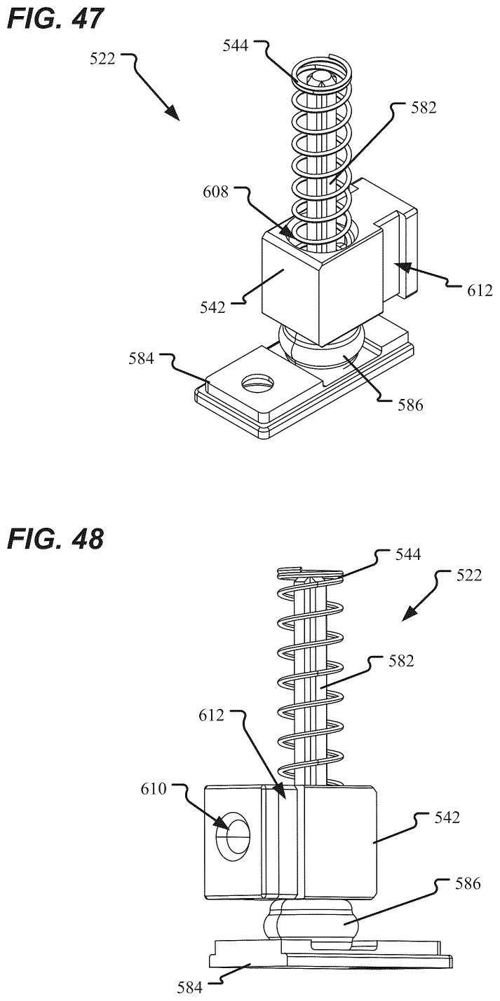

FIGS. 47-48 are perspective view of the portion of the drive assembly 522 disposed at the second handle mount 532 (shown in FIGS. 43 and 44). The second cover 584 includes the spring support 582 extending therefrom and with the bumper 586 at the base. The fixed handle mount 542 includes a longitudinal through-hole 608 that sliding receives the spring support 582 and so that the spring support 582 can move relative to the fixed handle mount 542 during operation of the handle assembly 500 (shown in FIG. 41). The fixed handle mount 542 also includes a transverse threaded bore 610 that receives the fastener 547 for coupling the fixed handle mount 542 to the escutcheon plate 502 (shown in FIG. 42). The outside surfaces of the fixed handle mount 542 define a longitudinal channel 612 that is shaped and sized to receive the longitudinal rib 590 of the second guide liner 578 (both shown in FIG. 43). Additionally, the distal end of the outer surface of the fixed handle mount 542 are received within the longitudinal channel 588 (shown in FIG. 43) of the second guide liner 578. The engagement between the fixed handle mount 542 and the second guide liner 578 facilitate the sliding movement of the handle 516 (shown in FIG. 43) relative to the escutcheon plate 502 and restricts the handle 516 from being pulled outward from the escutcheon plate 502. The biasing member 544 is at least partially seated within the longitudinal through-hole 608.

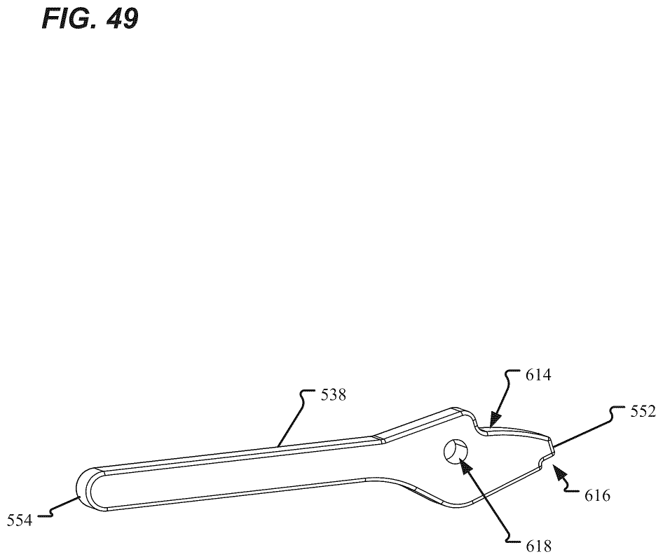

FIG. 49 is a perspective view of the drive arm 538 of the drive assembly 522 (shown in FIGS. 45-46). The first end 552 of the drive arm 538 is enlarged relative to the second end 554 of the drive arm 538. The first end 552 includes a convex upper surface 614 with a notch 616 partially underneath. The convex upper surface 614 is configured to engage with the corresponding curved surface of the contact surface 258 of the bracket of the transmission assembly (shown in FIGS. 21-22). The notch 616 provides clearance for the drive arm 538 within the transmission assembly. Extending from the convex upper surface 614 and the notch 616 are opposing substantially planar surfaces defining a thickened section that defines a hole 618 for receiving the pivot pin 550 (shown in FIG. 42). The second end 554 has a rounded distal end.

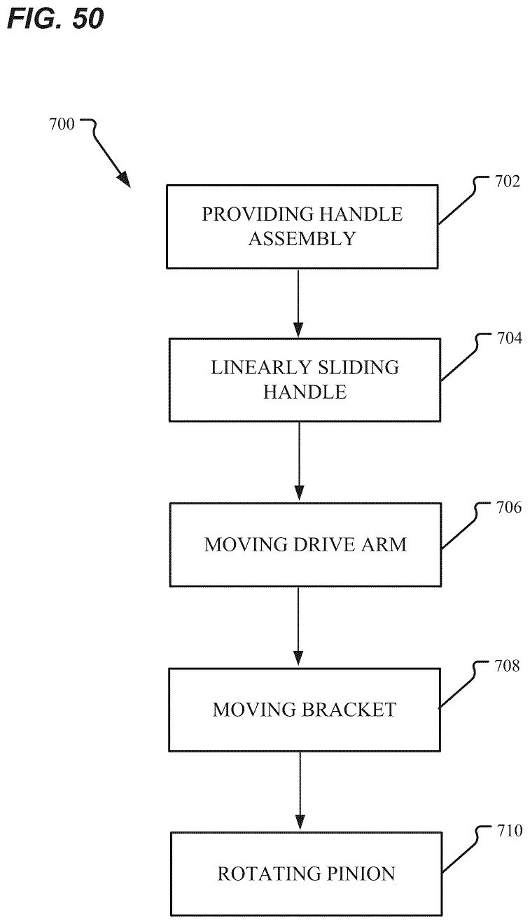

FIG. 50 is a flowchart illustrating a method 700 for unlatching a door. The example methods and operations can be implemented or performed by the assemblies described herein (e.g., the handle assemblies shown in FIGS. 1-49 and 51-52). The method 700 begins with providing the handle assembly in a latched configuration on the door (operation 702). In the latched configuration, the handle assembly includes a handle disposed in a latched position relative to at least one escutcheon plate. In the example, the latched position of the handle may be an upwards position relative to a vertical axis. Additionally, in the latched configuration, the handle assembly is operationally coupled to a latch assembly with a latch bolt that is in an extended position (e.g., extending out from an edge of the door for engagement with a corresponding keeper located on a door jamb).

The handle is then moved in a linear sliding direction along the vertical axis from the latched position towards an unlatched position (operation 704). In the example, the handle linearly slides relative to the at least one escutcheon plate in a downward direction along the vertical axis so as to position the handle in the unlatched position.

In response to the linear movement of the handle, the handle operates a drive assembly having a drive arm that moves via the handle (operation 706). In an example, the handle causes the drive arm to pivot. In another example, the handle causes the drive arm to slide linearly along the vertical axis. The drive arm is operatively coupled to a transmission assembly that is operatively coupled to the latch assembly. The transmission assembly generally includes a bracket that also moves along the vertical axis, a spring biasing the position of the bracket, and a rotatable pinion that couples to the latch assembly. The bracket moves via the drive arm along the vertical axis (operation 708). In an example, the pivoting movement of the drive arm causes the bracket to linearly move. In another example, the sliding movement of the drive arm causes the bracket to linearly move. Linear movement of the bracket drives rotation of the pinion (operation 710). This rotation of the pinion rotates a latch driver of the transmission assembly thereby retracting the latch bolt from the latch assembly and defining an unlatched configuration of the handle assembly.

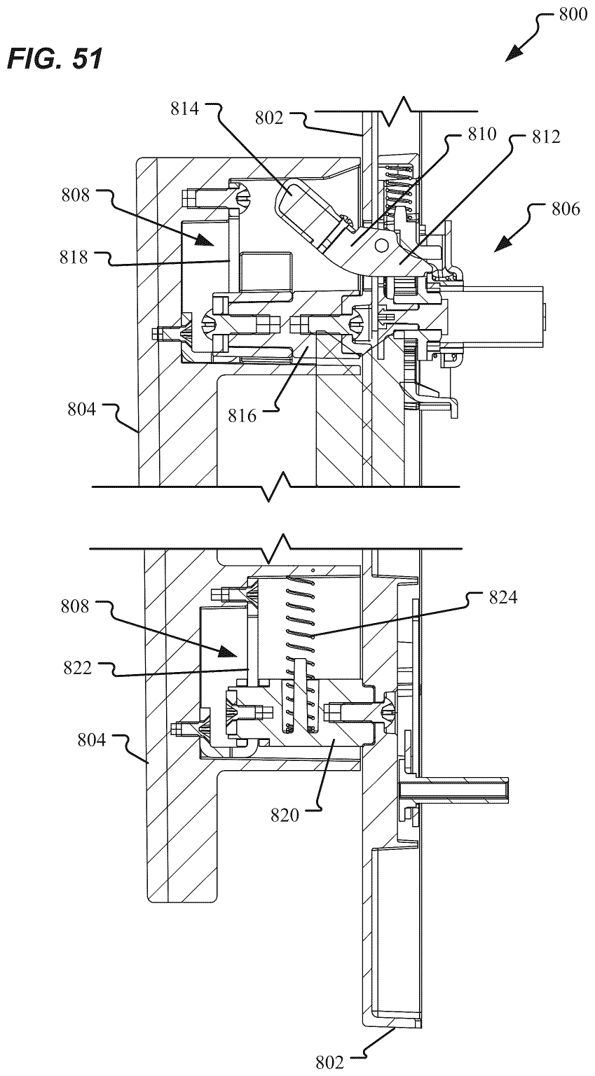

FIG. 51 is a cross-sectional view of another example of a handle assembly 800. Similar to the above-described examples, the handle assembly 800 includes an escutcheon plate 802 with a handle 804 slidingly coupled thereto and configured to operate a transmission assembly 806 so as to transfer linear movement of the handle 804 into rotational movement. As such, certain components are described above and are not described further below. In this example, a drive assembly 808 includes a pivoting drive arm 810 that has a dog leg shape and with a first end 812 disposed at an obtuse angle relative to the second end 814. The first end 812 is engaged with the transmission assembly 806 and the second end 814 is configured to slide against an inner surface of the handle 804.

Additionally, a first fixed handle mount 816 extends from the escutcheon plate 802 and a distal end of the first fixed handle mount 816 slidably engages a first bracket assembly 818 disposed within the handle 804. In an aspect, the first bracket assembly 818 has a bracket that is J-shaped with fasteners coupling the ends to the handle 804. The bracket has a center opening that captures the distal end of the first fixed handle mount 816 so that the handle 804 can slide relative to the first fixed handle mount 816. In an example, projecting wings may extend from the bracket to provide stability for the sliding movement. The drive arm 810 and the first fixed handle mount 816 are disposed at the first handle mount of the handle 804.

The drive assembly 808 also includes a second fixed handle mount 820 that extends from the escutcheon plate 802 at the second handle mount of the handle 804. A distal end of the second fixed handle mount 820 slidably engages a second bracket assembly 822 that is the same or similar to the first bracket assembly 818. A biasing member 824 (e.g., a compression spring) is disposed between the second fixed handle mount 820 and the handle 804 so as to bias the handle 804 relative to the escutcheon plate 802. In operation, sliding movement of the handle 804 is configured to pivot the drive arm 810 while the bracket assemblies 818, 822 are configured to retain the handle 804 on the escutcheon plate 802.

FIG. 52 is a cross-sectional view of another example of a handle assembly 900. Similar to the above-described examples, the handle assembly 900 includes an escutcheon plate 902 with a handle 904 slidingly coupled thereto and configured to operate a transmission assembly 906 so as to transfer linear movement of the handle 904 into rotational movement. As such, certain components are described above and are not described further below. In this example, a drive assembly 908 includes a pivoting drive arm 910 with a first end 912 engaged with the transmission assembly 906 and an opposite second end 914. The second end 914 defines a curved upper camming surface that is engaged with a curved lower camming surface of a cam 916 disposed within the first handle mount of the handle 904. In the example, the cam 916 is formed within a first housing 918 that is coupled the handle 904 and that receives the second end 914 of the drive arm 910. The first housing 918 also has a channel that slidably engages an extension from the transmission assembly 906 so as to retain the handle 904 on the escutcheon plate 902.

In operation, the engagement between the second end 914 of the drive arm 910 and the cam 916 provides the pivoting movement of the drive arm 910 when the handle 904 slides relative to the escutcheon plate 902. The biasing force of the transmission assembly 906 provides the biasing force to the handle 904. At the second handle mount of the handle 904, a fixed handle mount 920 extends from the escutcheon plate 902 and slides within channels formed within a second housing 922 that is coupled to the handle 904. The fixed handle mount 920 and the second housing 922 are configured to retain the handle 904 on the escutcheon plate 902 and enable the sliding movement as described herein.

The handle assemblies described herein are configured to operate a corresponding latch assembly to extend and retract a latch bolt with a sliding operation of a handle. Accordingly, an aesthetic handleset can be provided without additional latch actuation mechanisms. In the examples, the handle linearly slides relative to an escutcheon plate and, via a drive assembly, translates the linear motion of the handle into rotational movement for operation of the latch assembly. The drive assembly is at least partially disposed within the handle and is covered thereby. The drive assembly drives operation of a transmission assembly that is coupled to the latch assembly. In some examples, the drive assembly completely linearly slides with the handle for operation of the transmission assembly. In other examples, at least some components of the drive assembly pivot via movement of the handle for operation of the transmission assembly. The drive assembly also biases the handle so that the latch assembly can automatically returned to a latched configuration.

### Examples

Illustrative examples of the handle assembly disclosed herein are provided below. An embodiment of the handle assembly may include any one or more, and any combination of the examples described below.

Example 1. A handle assembly for a door comprising: a handle; an upper escutcheon plate mounted to a face of the door; a transmission assembly including a spring, a compression bracket, and a latch pinion; and a handle slide pin extending from the handle through the upper escutcheon plate and into the transmission assembly contacting the compression bracket; wherein the handle is slidable in a slide direction parallel to the face of the door between a latched position and an unlatched position, the handle and the handle slide pin spring biased to the latched position by the spring, the spring engaged with the compression bracket, the spring compressible in response to the handle moving from the latched position to the unlatched position, the compression bracket moving with the handle slide pin and rotating a latch pinion.

Example 2. The handle assembly of any one of examples 1-43, wherein the handle is slidably engaged with the upper escutcheon plate.

Example 3. The handle assembly of any one of examples 1-43, wherein the handle includes an upper handle mount, wherein the upper handle mount includes a first pin cavity for securing a bolt that slidably engages the handle with the upper escutcheon plate.

Example 4. The handle assembly of any one of examples 1-43, wherein the upper handle mount includes a second pin cavity for securing an end of the handle slide pin.

Example 5. The handle assembly of any one of examples 1-43, wherein the upper escutcheon plate includes a slot with an upper slot portion and a lower slot portion, wherein the handle slide pin extends through the upper escutcheon plate at the lower slot portion.

Example 6. The handle assembly of any one of examples 1-43, wherein the upper slot portion includes a shoulder sized for the head of a bolt, wherein the bolt slidably connects the handle to the upper escutcheon plate, and wherein the shoulder prevents the bolt from travelling into the lower slot portion.

Example 7. The handle assembly of any one of examples 1-43, wherein the upper escutcheon plate includes first and second handle alignment features preventing handle movement normal to the slide direction and parallel with the face of the door.

Example 8. The handle assembly of any one of examples 1-43, wherein the handle slide pin has a first portion with a first width and a second portion with a second width, wherein the first and second portions contact the compression bracket.

Example 9. The handle assembly of any one of examples 1-43, wherein the compression bracket includes a spring leg positioned at least partially within one end of the spring.

Example 10. The handle assembly of any one of examples 1-43, wherein the compression bracket includes a rack movable parallel to the slide direction.

Example 11. The handle assembly of any one of examples 1-43, wherein the rack contacts the pinion such that movement of the rack results in rotation of the latch pinion.

Example 12. The handle assembly of any one of examples 1-43, wherein the latch pinion rotates about a rotation axis, wherein the rotation axis is normal to the slide direction.

Example 13. The handle assembly of any one of examples 1-43, wherein the handle assembly further includes a lower handle mount and a lower escutcheon plate, wherein the lower handle mount is secured to the lower escutcheon plate, wherein the handle slidably engages the lower handle mount.

Example 14. The handle assembly of any one of examples 1-43, wherein the handle includes a T-channel at a lower portion of the handle, wherein the T-channel slidably engages a head of a bolt extending from the lower handle mount.

Example 15. The handle assembly of any one of examples 1-43, the T-channel allows movement in the slide direction and prevents movement in all other directions.

Example 16. A method of unlatching a door with a handle assembly comprising: moving a handle in a linear slide direction parallel to an outer surface of the door from a latched position to an unlatched position; moving a handle slide pin in the slide direction in response to the linear movement of the handle; moving a compression bracket in the slide direction in response to the linear movement of the handle slide pin; rotating a latch pinion about a rotation axis in response to engagement of the latch pinion by the linear movement of the compression bracket; and rotating a latch driver from the latched position to the unlatched position about the rotation axis in conjunction with rotation of the latch pinion.

Example 17. The method of any one of examples 1-43, wherein the method further includes compressing a spring in response to the linear movement of the compression bracket, the spring biasing the handle toward the latched position.

Example 18. The method of any one of examples 1-43, wherein the handle slide pin moves from a first position to a second position when the handle moves from the latched position to the unlatched position.

Example 19. The method of any one of examples 1-43, wherein the rotation axis is normal to the slide direction.

Example 20. A handle assembly for a door comprising: a handle movable in a slide direction between a first position and a second position parallel to a face of the door; a transmission assembly; and a handle slide pin extending from the handle to the transmission assembly, the handle slide pin movable in response to movement of the handle; the transmission assembly having a compression bracket with a rack and a latch pinion engaged with the rack such that linear movement of the rack causes rotational movement of the latch pinion, the compression bracket movable in response to movement of the handle slide pin, the first position defining a latched state and the second position defining an unlatched state.

Example 21. The handle assembly of any one of examples 1-43, wherein the handle assembly further includes an upper escutcheon plate, wherein the upper escutcheon plate includes a slot, the handle slide pin extending through the slot.

Example 22. The handle assembly of any one of examples 1-43, wherein the slot includes an upper slot portion and a lower slot portion, wherein the upper slot portion includes a shoulder sized for the head of a bolt, wherein the bolt slidably connects the handle to the upper escutcheon plate, and wherein the shoulder prevents the bolt from travelling into the lower slot portion.

Example 23. The handle assembly of any one of examples 1-43, wherein the upper escutcheon plate includes first and second handle alignment features engageable with the handle to limit movement of the handle normal to the slide direction and parallel with the face of the door.

Example 24. A handle assembly for a door includes: at least one escutcheon plate having a front face and an opposite rear face, the rear face configured to mount on a face of a door, the at least one escutcheon plate also having a first plate end and an opposite second plate end defining a longitudinal axis; a handle having a first handle end and an opposite second handle end, the handle elongated along the longitudinal axis, and the first and second handle ends each slidably coupled to the front face of the at least one escutcheon plate such that the handle is moveable between at least a latched position and an unlatched position along the longitudinal axis and relative to the at least one escutcheon plate; a transmission assembly mounted on the rear face of the at least one escutcheon plate, the transmission assembly including a bracket, a spring biasing a longitudinal position of the bracket, and a pinion rotatable around a rotation axis that is orthogonal to the longitudinal axis; and a drive assembly operationally coupling the handle to the transmission assembly, the drive assembly including a drive arm extending through the at least one escutcheon plate and having a first end engaged with the bracket of the transmission assembly and a second end disposed within the handle, wherein movement of the handle between the latched position and the unlatched position drives longitudinal movement of the bracket of the transmission assembly via the drive arm for rotation of the pinion around the rotation axis.

Example 25. The handle assembly of any one of examples 1-43, wherein the drive arm is pivotable around a pivot axis orthogonal to the longitudinal axis and the rotation axis, a longitudinal direction of movement of the handle being opposite of the longitudinal direction of movement of the bracket.

Example 26. The handle assembly of any one of examples 1-43, wherein the first handle end of the handle includes a first handle mount extending in a direction parallel to the rotation axis, the first handle mount defining a cavity for receiving the second end of the drive arm, wherein a roller is disposed within the cavity and engaged with the second end of the drive arm.

Example 27. The handle assembly of any one of examples 1-43, wherein the drive arm defines a length, a first length of the drive arm from the first end to the pivot axis less than a second length of the drive arm from the second end to the pivot axis.

Example 28. The handle assembly of any one of examples 1-43, wherein the second handle end of the handle includes a second handle mount extending in a direction parallel to the rotation axis, the second housing mount defining a cavity housing a second spring configured to bias the handle towards the latched position.

Example 29. The handle assembly of any one of examples 1-43, wherein the drive assembly further comprises a fixed handle mount fixedly coupled to the at least one escutcheon plate proximate the second plate end and slidably received within the cavity of the second housing mount, wherein the second spring extends between the fixed handle mount and an interior surface of the cavity of the second handle mount.

Example 30. The handle assembly of any one of examples 1-43, wherein the first handle end of the handle includes a first handle mount extending in a direction parallel to the rotation axis and the second handle end of the handle includes a second handle mount extending in a direction parallel to the rotation axis, wherein the handle slides a longitudinal distance between the latched position and the unlatched position, and wherein both the first handle mount and the second handle mount are elongated along the longitudinal axis and have an elongated length that is greater than the longitudinal distance that the handle slides.

Example 31. The handle assembly of any one of examples 1-43, wherein the drive arm is linearly slidably along the longitudinal axis, a longitudinal direction of movement of the handle being the same as the longitudinal direction of movement of the bracket.

Example 32. A handle assembly for a door including: at least one escutcheon plate configured to mount on a face of a door and defining a longitudinal axis; a handle including a first handle mount, a second handle mount, and a grip portion extending between the first and second handle mounts, the grip portion elongated along the longitudinal axis and the first and second handle mounts extending in a transverse direction orthogonal to the longitudinal axis, wherein the first and second handle mounts each are slidably coupled to the at least one escutcheon plate such that the handle is moveable between at least a latched position and an unlatched position along the longitudinal axis and relative to the at least one escutcheon plate; a transmission assembly mounted to the at least one escutcheon plate opposite the handle, the transmission assembly including a bracket, a first spring biasing a longitudinal position of the bracket, and a rotatable pinion such that longitudinal movement is converted to rotational movement; and a drive assembly operationally coupling the handle to the transmission assembly, the drive assembly including: a drive arm extending through the at least one escutcheon plate and having a first end engaged with the bracket of the transmission assembly and a second end disposed within the first handle mount of the handle, the drive arm pivotable about a pivot point disposed between the first end and the second end; and a second spring disposed within the second handle mount of the handle and configured to bias the handle towards the latched position.

Example 33. The handle assembly of any one of examples 1-43, wherein the first spring biases the bracket in an opposite longitudinal direction than the second spring biasing the handle.

Example 34. The handle assembly of any one of examples 1-43, wherein the drive assembly further includes a roller engaged with the second end of the drive arm and disposed within the first handle mount.

Example 35. The handle assembly of any one of examples 1-43, wherein the second end of the drive arm is completely disposed within the first handle mount of the handle.

Example 36. The handle assembly of any one of examples 1-43, wherein the drive assembly further includes an alignment plate having a pair of alignment guides projecting from the at least one escutcheon plate with the drive arm disposed therebetween, wherein each alignment guide has an outer surface with a longitudinal channel received within the first handle mount.

Example 37. The handle assembly of any one of examples 1-43, wherein the drive assembly further includes a fixed housing mount coupled to the at least one escutcheon plate and disposed within the second handle mount, wherein the fixed housing mount has an outer surface with a pair of longitudinal channels that are received within the second handle mount.

Example 38. The handle assembly of any one of examples 1-43, wherein the first handle mount defines an interior cavity, the drive assembly including a guide liner coupled within the interior cavity and configured to receive at least a portion of the drive arm.

Example 39. The handle assembly of any one of examples 1-43, wherein the second handle mount defines an interior cavity, the drive assembly including a guide liner coupled within the interior cavity and configured to house the second spring.

Example 40. A method of unlatching a door with a handle assembly including: providing the handle assembly in a latched configuration on the door, the handle assembly comprising at least one escutcheon plate defining a longitudinal axis mounted vertically on the door and a handle slidably coupled to the at least one escutcheon plate, the handle biased towards a latched position; moving the handle in a linear sliding direction along the longitudinal axis from the latched position towards an unlatched position; and wherein in response to the linear movement of the handle: moving a drive arm via the handle, the drive arm coupled to a transmission assembly having a bracket, a spring biasing a longitudinal position of the bracket, and a rotatable pinion; moving the bracket via the drive arm along the longitudinal axis; and rotating the pinion around a rotation axis orthogonal to the longitudinal axis via the bracket and to rotate a latch driver of the handle assembly thereby defining an unlatched configuration of the handle assembly, wherein rotation of the pinion causes a latch bolt of an attached latch assembly to retract relative to the door.

Example 41. The method of any one of examples 1-43, wherein moving the handle towards the unlatched configuration further includes at least partially overcoming a biasing spring force of a second spring disposed within the handle.

Example 42. The method of any one of examples 1-43, further comprising automatically returning the handle to the latched position via at least partially the second spring.

Example 43. The method of any one of examples 1-43, wherein moving the drive arm via the handle includes pivoting the drive arm so as to move the bracket in an opposite longitudinal direction relative to the handle.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, may not be included or may be combined with other features.

References in the specification to “one example,” “an example,” “an illustrative example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). Moreover, one having skill in the art will understand the degree to which terms such as “about,” “approximately,” or “substantially” convey in light of the measurement techniques utilized herein. To the extent such terms may not be clearly defined or understood by one having skill in the art, the term “about” shall mean plus or minus ten percent.

Throughout this description, references to orientation (e.g., front (ward), rear (ward), top, bottom, back, right, left, upper, lower, etc.) of the components of the handle assembly relate to their position when installed on a door and are used for ease of description and illustration only. No restriction is intended by use of the terms regardless of how the components of the handle assembly are situated on its own. As used herein, the terms “axial” and “longitudinal” refer to directions and orientations, which extend substantially parallel to a centerline of the component or system. Moreover, the terms “radial” and “radially” refer to directions and orientations, which extend substantially perpendicular to the centerline of the component or system. In addition, as used herein, the term “circumferential” and “circumferentially” refer to directions and orientations, which extend arcuately about the centerline of the component or system.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A handle assembly for a door comprising:
at least one escutcheon plate having a front face and an opposite rear face, the rear face configured to mount on a face of a door, the at least one escutcheon plate also having a first plate end and an opposite second plate end defining a longitudinal axis;
a handle having a first handle end and an opposite second handle end, the handle elongated along the longitudinal axis, and the first and second handle ends each slidably coupled to the front face of the at least one escutcheon plate such that the handle is moveable between at least a latched position and an unlatched position along the longitudinal axis and relative to the at least one escutcheon plate;
a transmission assembly mounted on the rear face of the at least one escutcheon plate, the transmission assembly including a bracket, a spring biasing a longitudinal position of the bracket, and a pinion rotatable around a rotation axis that is orthogonal to the longitudinal axis; and
a drive assembly operationally coupling the handle to the transmission assembly, the drive assembly including a drive arm extending through the at least one escutcheon plate and having a first end engaged with the bracket of the transmission assembly and a second end disposed within the handle, wherein movement of the handle between the latched position and the unlatched position drives longitudinal movement of the bracket of the transmission assembly via the drive arm for rotation of the pinion around the rotation axis.

2. The handle assembly of claim 1, wherein the drive arm is pivotable around a pivot axis orthogonal to the longitudinal axis and the rotation axis, a longitudinal direction of movement of the handle being opposite of the longitudinal direction of movement of the bracket.

3. The handle assembly of claim 2, wherein the first handle end of the handle includes a first handle mount extending in a direction parallel to the rotation axis, the first handle mount defining a cavity for receiving the second end of the drive arm, wherein a roller is disposed within the cavity and engaged with the second end of the drive arm.

4. The handle assembly of claim 2, wherein the drive arm defines a length, a first length of the drive arm from the first end to the pivot axis less than a second length of the drive arm from the second end to the pivot axis.

5. The handle assembly of claim 1, wherein the second handle end of the handle includes a second handle mount extending in a direction parallel to the rotation axis, the second housing mount defining a cavity housing a second spring configured to bias the handle towards the latched position.

6. The handle assembly of claim 5, wherein the drive assembly further comprises a fixed handle mount fixedly coupled to the at least one escutcheon plate proximate the second plate end and slidably received within the cavity of the second housing mount, wherein the second spring extends between the fixed handle mount and an interior surface of the cavity of the second handle mount.

7. The handle assembly of claim 1, wherein the first handle end of the handle includes a first handle mount extending in a direction parallel to the rotation axis and the second handle end of the handle includes a second handle mount extending in a direction parallel to the rotation axis, wherein the handle slides a longitudinal distance between the latched position and the unlatched position, and wherein both the first handle mount and the second handle mount are elongated along the longitudinal axis and have an elongated length that is greater than the longitudinal distance that the handle slides.

8. The handle assembly of claim 1, wherein the drive arm is linearly slidably along the longitudinal axis, a longitudinal direction of movement of the handle being the same as the longitudinal direction of movement of the bracket.

9. A handle assembly for a door comprising:
at least one escutcheon plate configured to mount on a face of a door and defining a longitudinal axis;
a handle including a first handle mount, a second handle mount, and a grip portion extending between the first and second handle mounts, the grip portion elongated along the longitudinal axis and the first and second handle mounts extending in a transverse direction orthogonal to the longitudinal axis, wherein the first and second handle mounts each are slidably coupled to the at least one escutcheon plate such that the handle is moveable between at least a latched position and an unlatched position along the longitudinal axis and relative to the at least one escutcheon plate;
a transmission assembly mounted to the at least one escutcheon plate opposite the handle, the transmission assembly including a bracket, a first spring biasing a longitudinal position of the bracket, and a rotatable pinion such that longitudinal movement is converted to rotational movement; and
a drive assembly operationally coupling the handle to the transmission assembly, the drive assembly including:
a drive arm extending through the at least one escutcheon plate and having a first end engaged with the bracket of the transmission assembly and a second end disposed within the first handle mount of the handle, the drive arm pivotable about a pivot point disposed between the first end and the second end; and
a second spring disposed within the second handle mount of the handle and configured to bias the handle towards the latched position.

10. The handle assembly of claim 9, wherein the first spring biases the bracket in an opposite longitudinal direction than the second spring biasing the handle.

11. The handle assembly of claim 9, wherein the drive assembly further includes a roller engaged with the second end of the drive arm and disposed within the first handle mount.

12. The handle assembly of claim 9, wherein the second end of the drive arm is completely disposed within the first handle mount of the handle.

13. The handle assembly of claim 9, wherein the drive assembly further includes an alignment plate having a pair of alignment guides projecting from the at least one escutcheon plate with the drive arm disposed therebetween, wherein each alignment guide has an outer surface with a longitudinal channel received within the first handle mount.

14. The handle assembly of claim 9, wherein the drive assembly further includes a fixed housing mount coupled to the at least one escutcheon plate and disposed within the second handle mount, wherein the fixed housing mount has an outer surface with a pair of longitudinal channels that are received within the second handle mount.

15. The handle assembly of claim 9, wherein the first handle mount defines an interior cavity, the drive assembly including a guide liner coupled within the interior cavity and configured to receive at least a portion of the drive arm.

16. The handle assembly of claim 9, wherein the second handle mount defines an interior cavity, the drive assembly including a guide liner coupled within the interior cavity and configured to house the second spring.

17. A method of unlatching a door with a handle assembly comprising:
providing the handle assembly in a latched configuration on the door, the handle assembly comprising at least one escutcheon plate defining a longitudinal axis mounted vertically on the door and a handle slidably coupled to the at least one escutcheon plate, the handle biased towards a latched position;
moving the handle in a linear sliding direction along the longitudinal axis from the latched position towards an unlatched position; and
wherein in response to the linear movement of the handle:
moving a drive arm via the handle, the drive arm coupled to a transmission assembly having a bracket, a spring biasing a longitudinal position of the bracket, and a rotatable pinion;
moving the bracket via the drive arm along the longitudinal axis; and
rotating the pinion around a rotation axis orthogonal to the longitudinal axis via the bracket and to rotate a latch driver of the handle assembly thereby defining an unlatched configuration of the handle assembly, wherein rotation of the pinion causes a latch bolt of an attached latch assembly to retract relative to the door.

18. The method of claim 17, wherein moving the handle towards the unlatched configuration further includes at least partially overcoming a biasing spring force of a second spring disposed within the handle.

19. The method of claim 18, further comprising automatically returning the handle to the latched position via at least partially the second spring.

20. The method of claim 17, wherein moving the drive arm via the handle includes pivoting the drive arm so as to move the bracket in an opposite longitudinal direction relative to the handle.
